(19) United States
(12) Patent Application Publication
(10) Pub. No.: US 2023/0397288 A1
(43) Pub. Date: Dec. 7, 2023

(54) METHOD AND DEVICE USED FOR WIRELESS COMMUNICATION

(71) Applicants: Jinfang ZHANG, Shanghai (CN); Xiaobo ZHANG, Shanghai (CN)

(72) Inventors: Jinfang ZHANG, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/235,359

(22) Filed: Aug. 18, 2023

Related U.S. Application Data
(63) Continuation of application No. PCT/CN2022/085236, filed on Apr. 6, 2022.

(30) Foreign Application Priority Data
Apr. 6, 2021 (CN) 202110368521.2
Apr. 6, 2021 (CN) 202110369480.9

(51) Int. Cl. H04W 76/27

(52) U.S. Cl. CPC H04W 76/27; H04W 74/0833

(57) ABSTRACT

Discloses a method and a device for wireless communications. A first node maintains a first timer, and maintains a second timer; transmits a first message, the first message comprising an RRC signaling; and determines whether to switch an RRC state according to both a state of the first timer and a state of the second timer; herein, the action of maintaining a first timer comprises: along with the first message, starting the first timer; the action of determining whether to switch an RRC state according to both a state of the first timer and a state of the second timer comprises: when the second timer is not in a running state, as a response to that the first timer is expired, switching from an RRC inactive state to a first RRC state. The present application implements the failure detection of small data transmission.

### CROSS REFERENCE TO RELATED APPLICATIONS

This application is the continuation of the international patent application No. PCT/CN2022/085236, filed on Apr. 6, 2022, and claims the priority benefit of Chinese Patent Application No. 202110368521.2, filed on Apr. 6, 2021, and claims the priority benefit of Chinese Patent Application No. 202110369480.9, filed on Apr. 6, 2021, the full disclosure of which is incorporated herein by reference.

### BACKGROUND

### Technical Field

The present application relates to methods and devices in wireless communication systems, and in particular to a method and device supportive of transmitting small data in RRC Inactive state in wireless communications.

### Related Art

The RRC_INACTIVE state is a radio resource control (RRC) state newly introduced in New Radio (NR). When a user enters into an RRC inactive state, the user can retain some of network configuration information. When there arrives some traffics, the user can perform data transmission after re-entering into an RRC_CONNECTED state. Not until Rel-16 will data transmission in an RRC inactive state be supported in the 3rd Generation Partner Project (3GPP) Radio Access Network (RAN).

As the application scenarios of the future wireless communication system become more and more diverse, small data service will play a significant role in future wireless communications with the rapid development of the Internet of Things (IoT). When it comes to small data transmission, the signaling overhead of RRC state transition is larger than the transmission overhead of small data, and meanwhile the overhead of the UE power consumption is also increased. Therefore, it was decided at the 3GPP RAN #88e plenary that a Work Item (WI) is to be conducted to standardize small data transmission in the RRC inactive state.

### SUMMARY

Inventors find through researches that a UE can transmit small data in an RRC inactive state by means of a random access procedure or using configured grant radio resources, and in order to prevent a failure of small data transmission procedure due to the system congestion or a link failure, it is necessary to define a mechanism of failure detection.

To address the above issue, the present application provides a solution of failure detection of small data transmission in the RRC inactive state, which introduces two new timers, and detects whether the small data transmission procedure is failed according to whether the two timers are expired.

To address the above issue, the present application provides a solution of failure detection of small data transmission in the RRC inactive state, which introduces a new timer, and detects whether the small data transmission procedure is failed according to whether the timer is expired, thus acquiring the beneficial effect of keeping the RRC states of the network and the UE consistent.

In the case of no conflict, the embodiments of a first node and the characteristics in the embodiments may be applied to a second node, and vice versa. What's more, the embodiments in the present application and the characteristics in the embodiments can be arbitrarily combined if there is no conflict. Further, though originally targeted at the Uu air interface, the present application also applies to the PC5 interface. Further, the present application is designed targeting terminal-base station scenario, but can be extended to Vehicle-to-Everything (V2X), terminal-relay communications, as well as relay-base station communications, where similar technical effects can be achieved. Additionally, the adoption of a unified solution for various scenarios, including but not limited to V2X and terminal-base station communications, contributes to the reduction of hardcore complexity and costs. Particularly, for interpretations of the terminology, nouns, functions and variables (unless otherwise specified) in the present application, refer to definitions given in TS36 series, TS38 series and TS37 series of 3GPP specifications.

The present application provides a method in a first node for wireless communications, comprising:
maintaining a first timer, and maintaining a second timer; and
transmitting a first message, the first message comprising an RRC signaling; and determining whether to switch an RRC state according to both a state of the first timer and a state of the second timer;
herein, the action of maintaining a first timer comprises: along with the first message, starting the first timer; the action of maintaining a second timer comprises: as a response to receiving a first-type data unit or as a response to transmitting the first-type data unit, starting or restarting the second timer; the action of determining whether to switch an RRC state according to both a state of the first timer and a state of the second timer comprises: when the second timer is not in a running state, as a response to that the first timer is expired, switching from an RRC inactive state to a first RRC state, or when the second timer is in the running state, that the first timer is expired not triggering a switch from the RRC inactive state to the first RRC state; the first RRC state is a candidate state in a first candidate state set, the first candidate state set comprising an RRC idle state.

In one embodiment, the present application is applicable to a small data transmission procedure in the RRC inactive state.

In one embodiment, the present application is applicable to scenarios of transmitting small data through a random access procedure.

In one embodiment, the present application is applicable to scenarios of transmitting small data through configured grant radio resources.

In one embodiment, the present application is applicable to a small data transmission (SDT) procedure in the RRC inactive state.

In one embodiment, an issue to be solved in the present application is: the mechanism of failure detection in small data transmission in the RRC inactive state.

In one embodiment, a solution given in the present application includes: introducing two new timers and detecting whether a small data transmission procedure is failed according to whether these two timers are expired.

In one embodiment, a beneficial effect of the present application includes: implementing a failure detection during the procedure of small data transmission in the RRC inactive state.

In one embodiment, due to the uncertainty of delay in subsequent data transmission in the small data transmission procedure, if detecting whether the small data transmission is failed only according to whether the first timer is expired, the configuration of an expiration value of the first timer will be hard to design; but to determine whether the small data transmission is failed by combining a state of the first timer and a state of the second timer can effectively solve the problem.

In one embodiment, in the case that there is subsequent data being transmitted in a small data transmission procedure, when transmitting the first-type data unit or receiving the first-type data unit, the second timer can be restarted to avoid the situation where the subsequent data transmission is interrupted before completion, due to the first timer's switch from an RRC inactive state to a first RRC state upon its expiration.

According to one aspect of the present application, comprising:
when the first timer is not in a running state, as a response to that the second timer is expired, switching from the RRC inactive state to the first RRC state; when the first timer is in the running state, that the second timer is expired not triggering a switch from the RRC inactive state to the first RRC state.

According to one aspect of the present application, comprising:
as a response to that the second timer is expired, conveying a first indication from a MAC sublayer to upper layer(s);
herein, the second timer is maintained in the MAC sublayer; the first timer is maintained in an RRC sublayer.

According to one aspect of the present application, comprising:
receiving a third message;
herein, a time of receiving the third message is earlier than a time of transmitting the first message; the third message enables a first radio bearer set to be transmitted in the RRC inactive state; any first-type data unit belongs to a radio bearer in the first radio bearer set.

According to one aspect of the present application, comprising:
receiving a first data unit set after receiving the third message and before transmitting the first message;
herein, a data volume in the first data unit set is no larger than a first threshold; any data unit in the first data unit set belongs to the first-type data unit; the first node is in the RRC inactive state when transmitting the first message.

According to one aspect of the present application, comprising:
if a second message is received, and the first timer is in the running state, as a response to receiving the second message, stopping the first timer;
herein, the second message comprises an RRC signaling, and the second message is a response to the first message; the second message indicates the RRC state of the first node.

The present application provides a method in a second node for wireless communications, comprising:
receiving a first message, the first message comprising an RRC signaling; and a state of a first timer and a state of a second timer being used together for determining whether to switch an RRC state;
herein, the first timer is maintained, and the second timer is maintained; the first timer being maintained comprises: along with the first message, the first timer being started; the second timer being maintained comprises: as a response to receiving a first-type data unit or as a response to transmitting the first-type data unit, the second timer being started or restarted; that a state of a first timer and a state of a second timer are used together for determining whether to switch an RRC state comprises: when the second timer is not in a running state, as a response to that the first timer is expired, an RRC inactive state being switched to a first RRC state, or when the second timer is in the running state, that the first timer is expired not triggering a switch from the RRC inactive state to the first RRC state; the first RRC state is a candidate state in a first candidate state set, the first candidate state set comprising an RRC idle state.

According to one aspect of the present application, comprising:
when the first timer is not in a running state, as a response to that the second timer is expired, the RRC inactive state is switched to the first RRC state; when the first timer is in the running state, that the second timer is expired not triggering a switch from the RRC inactive state to the first RRC state.

According to one aspect of the present application, comprising:
as a response to that the second timer is expired, a first indication is conveyed from a MAC sublayer to upper layer(s);
herein, the second timer is maintained in the MAC sublayer; the first timer is maintained in an RRC sublayer.

According to one aspect of the present application, comprising:
transmitting a third message;
herein, a time of receiving the third message is earlier than a time of transmitting the first message; the third message enables a first radio bearer set to be transmitted in the RRC inactive state; any first-type data unit belongs to a radio bearer in the first radio bearer set.

According to one aspect of the present application, comprising:
a first data unit set being received after receiving the third message and before transmitting the first message;
herein, a data volume in the first data unit set is no larger than a first threshold; any data unit in the first data unit set belongs to the first-type data unit; a transmitter of the first message is in the RRC inactive state when transmitting the first message.

According to one aspect of the present application, comprising:
if a second message is received, and the first timer is in the running state, as a response to receiving the second message, the first timer being stopped;
herein, the second message comprises an RRC signaling, and the second message is a response to the first message; the second message indicates the RRC state of the transmitter of the first message.

The present application provides a first node for wireless communications, comprising:
a first receiver, maintaining a first timer, and maintaining a second timer; and
a first transmitter, transmitting a first message, the first message comprising an RRC signaling; and determining whether to switch an RRC state according to both a state of the first timer and a state of the second timer;
herein, the action of maintaining a first timer comprises: along with the first message, starting the first timer; the action of maintaining a second timer comprises: as a response to receiving a first-type data unit or as a response to transmitting the first-type data unit, starting or restarting the second timer; the action of determining whether to switch an RRC state according to both a state of the first timer and a state of the second timer comprises: when the second timer is not in a running state, as a response to that the first timer is expired, switching from an RRC inactive state to a first RRC state, or when the second timer is in the running state, that the first timer is expired not triggering a switch from the RRC inactive state to the first RRC state; the first RRC state is a candidate state in a first candidate state set, the first candidate state set comprising an RRC idle state.

The present application provides a second node for wireless communications, comprising:
a second receiver, receiving a first message, the first message comprising an RRC signaling; a state of a first timer and a state of a second timer being used together for determining whether to switch an RRC state;
herein, the first timer is maintained, and the second timer is maintained; the first timer being maintained comprises: along with the first message, the first timer being started; the second timer being maintained comprises: as a response to receiving a first-type data unit or as a response to transmitting the first-type data unit, the second timer being started or restarted; that a state of a first timer and a state of a second timer are used together for determining whether to switch an RRC state comprises: when the second timer is not in a running state, as a response to that the first timer is expired, an RRC inactive state being switched to a first RRC state, or when the second timer is in the running state, that the first timer is expired not triggering a switch from the RRC inactive state to the first RRC state; the first RRC state is a candidate state in a first candidate state set, the first candidate state set comprising an RRC idle state.

The present application provides a method in a first node for wireless communications, comprising:
maintaining a first timer; and
transmitting a first message, the first message comprising an RRC signaling; and as a response to that the first timer is expired, switching from an RRC inactive state to a first RRC state;
herein, the action of maintaining a first timer comprises: as a response to that a number of first-type data unit(s) transmitted after a most recent start of the first timer exceeds a first threshold, restarting the first timer; if a second message is received, as a response to receiving the second message, stopping the first timer, the second message comprising an RRC signaling, and the second message being used as a response to the first message; the first RRC state is a candidate state in a first candidate state set, the first candidate state set comprising an RRC idle state; the first threshold is configurable, or, the first threshold is a positive integer greater than 1.

In one embodiment, the present application is applicable to a small data transmission procedure in the RRC inactive state.

In one embodiment, the present application is applicable to scenarios of transmitting small data through a random access procedure.

In one embodiment, the present application is applicable to scenarios of transmitting small data through configured grant radio resources.

In one embodiment, the present application is applicable to a small data transmission (SDT) procedure in the RRC inactive state.

In one embodiment, an issue to be solved in the present application is: the mechanism of failure detection in small data transmission in the RRC inactive state.

In one embodiment, a solution given in the present application includes: introducing a new timer and detecting whether a small data transmission procedure is failed according to whether the timer is expired.

In one embodiment, a beneficial effect of the present application includes: implementing a failure detection during the procedure of small data transmission in the RRC inactive state.

In one embodiment, a beneficial effect of the present application includes: Switching from an RRC inactive state to a first RRC state when the first timer is expired, which helps keep the consistency of the RRC states of the network and the UE.

According to one aspect of the present application, comprising: [0073] as a response to that a number of first-type data unit(s) transmitted after a most recent start of the first timer exceeds a first threshold, conveying a first indication from a MAC sublayer to upper layer(s); [0074] herein, the first indication is used for triggering the action of restarting the first timer, where the number of the first-type data unit(s) is calculated in the MAC sublayer.

In one embodiment, in the case that there is subsequent data transmission in a small data transmission procedure, restarting the first timer based on the amount of data being transmitted can avoid the situation where the subsequent data transmission is interrupted before completion, due to the first timer's switch from an RRC inactive state to a first RRC state upon its expiration.

In one embodiment, in the case that there is subsequence data transmission in a small data transmission procedure, restarting the first timer based on the amount of data being transmitted can avoid the situation where the small data transmission procedure is triggered multiple times due to the expiration of the first timer, thereby reducing the signaling overhead and transmission delay.

In one embodiment, due to the uncertainty of delay in subsequent data transmission in the small data transmission procedure, there exists some designing difficulty when configuring the expiration value of the first timer; but this problem can be solved by restarting the first timer based on the amount of data being transmitted.

According to one aspect of the present application, comprising:
the first timer is maintained in an RRC sublayer.

According to one aspect of the present application, comprising:
receiving a third message;
herein, a time of receiving the third message is earlier than a time of transmitting the first message; the third message enables a first radio bearer set to be transmitted in the RRC inactive state; any first-type data unit belongs to a radio bearer in the first radio bearer set.

According to one aspect of the present application, comprising:
receiving a first data unit set after receiving the third message and before transmitting the first message;
herein, a data volume in the first data unit set is no larger than a first threshold; any data unit in the first data unit set belongs to the first-type data unit; the first node is in the RRC inactive state when transmitting the first message.

According to one aspect of the present application, comprising:
the second message indicating an RRC state of the first node.

The present application provides a method in a second node for wireless communications, comprising:
receiving a first message, the first message comprising an RRC signaling;
herein, a first timer is maintained; as a response to that the first timer is expired, an RRC inactive state is switched to a first RRC state; the first timer being maintained comprises: as a response to that a number of first-type data unit(s) transmitted after a most recent start of the first timer exceeds a first threshold, the first timerbeing restarted; if a second message is received, as a response to receiving the second message, the first timer being stopped, the second message comprising an RRC signaling, and the second message being used as a response to the first message; the first RRC state is a candidate state in a first candidate state set, the first candidate state set comprising an RRC idle state; the first threshold is configurable, or, the first threshold is a positive integer greater than 1.

According to one aspect of the present application, comprising:
as a response to that a number of first-type data unit(s) transmitted after a most recent start of the first timer exceeds a first threshold, a first indication being conveyed from a MAC sublayer to upper layers;
herein, the first indication is used for triggering that the first timer is restarted, where the number of the first-type data unit(s) is calculated in the MAC sublayer.

According to one aspect of the present application, comprising:
the first timer is maintained in an RRC sublayer.

According to one aspect of the present application, comprising:
transmitting a third message;
herein, a time of transmitting the third message is earlier than a time of receiving the first message; the third message enables a first radio bearer set to be transmitted in the RRC inactive state; any first-type data unit belongs to a radio bearer in the first radio bearer set.

According to one aspect of the present application, comprising:
a first data unit set being received after transmitting the third message and before receiving the first message;
herein, a data volume in the first data unit set is no larger than a first threshold; any data unit in the first data unit set belongs to the first-type data unit; a transmitter of the first message is in the RRC inactive state when transmitting the first message.

According to one aspect of the present application, comprising:
the second message indicates an RRC state of the transmitter of the first message.

The present application provides a first node for wireless communications, comprising:
a first receiver, maintaining a first timer; and
a first transmitter, transmitting a first message, the first message comprising an RRC signaling; as a response to that the first timer is expired, switching from an RRC inactive state to a first RRC state;
herein, the action of maintaining a first timer comprises: as a response to that a number of first-type data unit(s) transmitted after a most recent start of the first timer exceeds a first threshold, restarting the first timer; if a second message is received, as a response to receiving the second message, stopping the first timer, the second message comprising an RRC signaling, and the second message being used as a response to the first message; the first RRC state is a candidate state in a first candidate state set, the first candidate state set comprising an RRC idle state; the first threshold is configurable, or, the first threshold is a positive integer greater than 1.

The present application provides a second node for wireless communications, comprising:
a second receiver, receiving a first message, the first message comprising an RRC signaling;
herein, a first timer is maintained; as a response to that the first timer is expired, an RRC inactive state is switched to a first RRC state; the first timer being maintained comprises: as a response to that a number of first-type data unit(s) transmitted after a most recent start of the first timer exceeds a first threshold, the first timer being restarted; if a second message is received, as a response to receiving the second message, the first timer being stopped, the second message comprising an RRC signaling, and the second message being used as a response to the first message; the first RRC state is a candidate state in a first candidate state set, the first candidate state set comprising an RRC idle state; the first threshold is configurable, or, the first threshold is a positive integer greater than 1.

### BRIEF DESCRIPTION OF THE DRAWINGS

Other features, objects and advantages of the present application will become more apparent from the detailed description of non-restrictive embodiments taken in conjunction with the following drawings:

FIG. 1A illustrates a flowchart of transmission of a first node according to one embodiment of the present application.

FIG. 1B illustrates a flowchart of transmission of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of hardcore modules in a communication device according to one embodiment of the present application.

FIG. 5A illustrates a flowchart of radio signal transmission according to one embodiment of the present application.

FIG. 5B illustrates a flowchart of radio signal transmission according to one embodiment of the present application.

FIG. 6A illustrates a schematic diagram of inter-layer information interaction between an RRC sublayer and a MAC sublayer according to one embodiment of the present application.

FIG. 6B illustrates a schematic diagram of inter-layer information interaction between an RRC sublayer and a MAC sublayer according to one embodiment of the present application.

FIG. 7A illustrates a flowchart of processing while a second timer is not in a running state according to one embodiment of the present application.

FIG. 7B illustrates a flowchart of processing of a first node according to one embodiment of the present application.

FIG. 8A illustrates a flowchart of processing while a first timer is not in a running state according to one embodiment of the present application.

FIG. 8B illustrates a flowchart of a first timer according to one embodiment of the present application.

FIG. 9A illustrates a flowchart of processing while a first timer is in a running state and a second timer is in a running state according to one embodiment of the present application.

FIG. 9B illustrates a structure block diagram of a processing device in a first node according to one embodiment of the present application.

FIG. 10A illustrates a flowchart of a first timer according to one embodiment of the present application.

FIG. 10B illustrates a structure block diagram of a processing device in a second node according to one embodiment of the present application.

FIG. 11 illustrates a flowchart of a second timer according to one embodiment of the present application.

FIG. 12 illustrates a structure block diagram of a processing device in a first node according to one embodiment of the present application.

FIG. 13 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1A

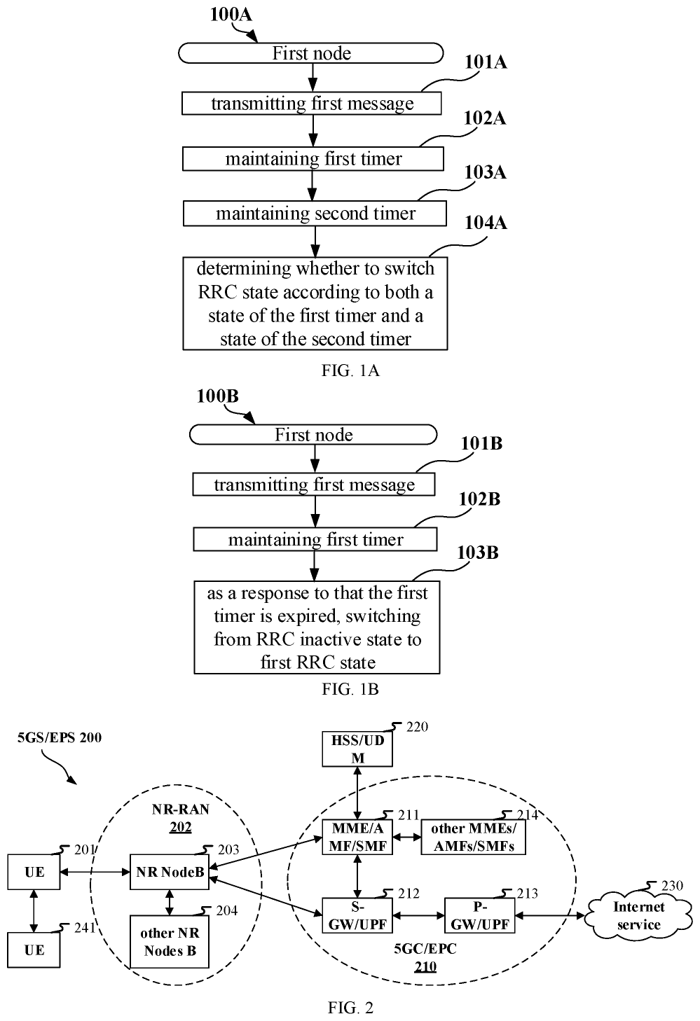

Embodiment 1A illustrates a flowchart of transmission of a first node according to one embodiment of the present application, as shown in FIG. 1A.

In Embodiment 1A, a first node 100A transmits a first message in step 101A, the first message comprising an RRC signaling; and maintains a first timer in step 102A; and maintains a second timer in step 103A; and determines in step 104A whether to switch an RRC state according to both a state of the first timer and a state of the second timer; herein, the action of maintaining a first timer comprises: along with the first message, starting the first timer; the action of maintaining a second timer comprises: as a response to receiving a first-type data unit or as a response to transmitting the first-type data unit, starting or restarting the second timer; the action of determining whether to switch an RRC state according to both a state of the first timer and a state of the second timer comprises: when the second timer is not in a running state, as a response to that the first timer is expired, switching from an RRC inactive state to a first RRC state, or when the second timer is in the running state, that the first timer is expired not triggering a switch from the RRC inactive state to the first RRC state; the first RRC state is a candidate state in a first candidate state set, the first candidate state set comprising an RRC idle state.

In one embodiment, the first message is transmitted through an air interface.

In one embodiment, the air interface includes an interface of radio signal transmission.

In one embodiment, the air interface includes an interface of radio signaling transmission.

In one embodiment, the air interface includes a Uu.

In one embodiment, the air interface includes a PC5.

In one embodiment, the first message comprises contents buffered in a Message A (MsgA).

In one embodiment, the first message comprises contents buffered in a Message 3 (Msg3).

In one embodiment, the first message belongs to a Random Access (RA) procedure.

In one embodiment, the first message is a Msg3 in a 4-step random access procedure.

In one embodiment, the first message is a MsgA in a 2-step random access procedure.

In one embodiment, a radio resource occupied by the first message is with Configured Grant (CG).

In one embodiment, the first message comprises a Medium Access Control (MAC) Protocol Data Unit (PDU).

In one embodiment, a MAC PDU comprises at least one MAC subPDU, the MAC subPDU comprising a MAC subheader, or the MAC subPDU comprising a MAC subheader and a MAC Service Data Unit (SDU), or the MAC subPDU comprising a MAC subheader and a MAC Control Element (CE), or the MAC subPDU comprising a MAC subheader and padding.

In one embodiment, the first message only comprises at least partial bits in a first-type data unit.

In one embodiment, the first message comprises at least partial bits in the first-type data unit.

In one embodiment, the first message comprises an RRC signaling.

In one embodiment, the first message comprises an RRC signaling and at least partial bits in the first-type data unit.

In one embodiment, the first message comprises at least two MAC SDUs, the at least two MAC SDUs respectively comprising an RRC signaling and at least partial bits in the first-type data unit.

In one embodiment, the first message comprises a Buffer Status Report (BSR).

In one embodiment, an RRC signaling comprised by the first message belongs to a Common Control Channel (CCCH).

In one embodiment, an RRC signaling comprised by the first message belongs to a Signaling Radio Bearer 0 (SRB0).

In one embodiment, the first message comprises a RRCResumeRequest.

In one embodiment, the first message comprises a RRCResumeRequest1.

In one embodiment, when the first message comprises a RRCResumeRequest, a resumeIdentity field comprised by the first message comprises 24 bits; when the first message comprises a RRCResumeRequest1, a resumeIdentity field comprised by the first message comprises 40 bits.

In one embodiment, the first message comprises a resumeCause field.

In one embodiment, a name of a resumeCause comprised by the first message includes small data transmission (SDT).

In one embodiment, a resumeCause comprised by the first message is an SDT.

In one embodiment, a resumeCause comprised by the first message is a mobile originated (mo)-SDT.

In one embodiment, a resumeCause comprised by the first message is a mo-Short Message Service (SMS).

In one embodiment, a resumeCause comprised by the first message is an emergency.

In one embodiment, a resumeCause comprised by the first message is a mobile terminated (mt)-SDT.

In one embodiment, a resumeCause comprised by the first message is a mo-signalling.

In one embodiment, the first message comprises a RRCReestablishmentRequest.

In one embodiment, the first message comprises a ReestablishmentCause field.

In one embodiment, a ReestablishmentCause comprised by the first message is an SDT.

In one embodiment, the first timer is maintained in the RRC sublayer.

In one embodiment, only when the first node is in the RRC inactive state will the first timer be setup.

In one embodiment, when the first node is in the RRC_IDLE state or the RRC_Connected state, the first timer is released.

In one embodiment, the first timer only runs while the first node is in the RRC inactive state.

In one embodiment, the action of maintaining a first timer comprises: along with the first message, starting the first timer.

In one embodiment, the phrase that along with the first message, starting the first timer comprises that: starting the first timer and transmitting the first message are inseparable (that is, atomic).

In one embodiment, the phrase that along with the first message, starting the first timer comprises that: transmitting the first message and starting the first timer are mutually accompanied.

In one embodiment, the phrase that along with the first message, starting the first timer comprises that: transmitting the first message is used for starting the first timer.

In one embodiment, the phrase that along with the first message, starting the first timer comprises that: upon transmission of the first message, starting the first timer.

In one embodiment, the phrase that along with the first message, starting the first timer comprises that: following the transmission of the first message, starting the first timer.

In one embodiment, the phrase that along with the first message, starting the first timer comprises that: following the start of the first timer, transmitting the first message.

In one embodiment, the phrase that along with the first message, starting the first timer comprises that: upon initiation of the procedure of random access to which the first message belongs, starting the first timer.

In one embodiment, the phrase that along with the first message, starting the first timer comprises that: following the initiation of the procedure of random access to which the first message belongs, starting the first timer.

In one embodiment, the phrase that along with the first message, starting the first timer comprises that: following the start of the first timer, initiating the procedure of random access to which the first message belongs.

In one embodiment, the phrase that along with the first message, starting the first timer comprises that: upon initiation of a small data transmission procedure to which the first message belongs, starting the first timer.

In one embodiment, the phrase that along with the first message, starting the first timer comprises that: following the small data transmission procedure to which the first message belongs, starting the first timer.

In one embodiment, the phrase that along with the first message, starting the first timer comprises that: following the start of the first timer, initiating the small data transmission procedure to which the first message belongs.

In one embodiment, the phrase that along with the first message, starting the first timer comprises that: upon transmission of a first said first-type data unit after transmitting the first message, starting the first timer.

In one embodiment, the phrase that along with the first message, starting the first timer comprises that: upon reception of a first said first-type data unit after transmitting the first message, starting the first timer.

In one embodiment, when the action of starting the first timer occurs, the first timer is in the non-running state.

In one embodiment, the phrase of starting the first timer comprises: the first timer beginning its time-counting.

In one embodiment, the phrase that along with the first message, starting the first timer comprises that: transmitting the first message does not start a timer T319.

In one embodiment, transmitting the first-type data unit does not start or restart the T319.

In one embodiment, along with the first message, starting the first timer, the first message comprising at least partial bits in at least one of the first-type data units; along with a fourth message, starting the timer T319, the fourth message not comprising the first-type data unit(s).

In one embodiment, the first timer and the timer T319 are orthogonal in running time.

In one embodiment, the fourth message comprises an RRC signaling.

In one embodiment, the fourth message comprises a RRCResumeRequest.

In one embodiment, the fourth message comprises a RRCResumeRequest1.

In one embodiment, a MAC SDU comprised by the fourth message only comprises an RRC signaling.

In one embodiment, a MAC SDU comprised by the fourth message only comprises a CCCH.

In one embodiment, a random access procedure to which the first message belongs is used for SDT; a random access procedure to which the fourth message belongs is used for functions other than SDT.

In one embodiment, a random access procedure to which the fourth message belongs is used for an initial access to an RRC idle state.

In one embodiment, a random access procedure to which the fourth message belongs is used for an RRC re-establishment procedure.

In one embodiment, a random access procedure to which the fourth message belongs is used for implementing uplink synchronization.

In one embodiment, a random access procedure to which the fourth message belongs is used for acquiring uplink transmission resource.

In one embodiment, a random access procedure to which the fourth message belongs is used for a Scheduling Request (SR) failure.

In one embodiment, a random access procedure to which the fourth message belongs is used for handover.

In one embodiment, a random access procedure to which the fourth message belongs is used for switching from an RRC inactive state to an RRC state.

In one embodiment, a random access procedure to which the fourth message belongs is used for setting up time alignment with a Timing Advance Group (TAG).

In one embodiment, a random access procedure to which the fourth message belongs is used for acquiring other system information.

In one embodiment, a random access procedure to which the fourth message belongs is used for a beam failure recovery.

In one embodiment, a random access procedure to which the fourth message belongs is used for constant uplink Listen Before Talk (LBT) failures on a Special Cell (SpCell).

In one embodiment, the second timer is maintained in the MAC sublayer.

In one embodiment, only when the first node is in the RRC inactive state will the second timer be setup.

In one embodiment, when the first node is in the RRC_IDLE state or the RRC_Connected state, the second timer is released.

In one embodiment, the second timer only runs while the first node is in the RRC inactive state.

In one embodiment, a name of the second timer includes SDT.

In one embodiment, the action of maintaining a second timer comprises: as a response to receiving a first-type data unit or as a response to transmitting the first-type data unit, starting or restarting the second timer.

In one embodiment, receiving a first-type data unit or transmitting the first-type data unit comprises: receiving at least partial bits in at least one of the first-type data units or transmitting at least partial bits in at least one of the first-type data units.

In one embodiment, the action of maintaining a second timer comprises: in the RRC inactive state, as a response to receiving the first-type data unit or as a response to transmitting the first-type data unit, starting or restarting the second timer.

In one embodiment, the action of maintaining a second timer comprises: in the RRC inactive state, as a response to receiving a first-type data unit, starting or restarting the second timer.

In one embodiment, the action of maintaining a second timer comprises: in the RRC inactive state, as a response to transmitting the first-type data unit, starting or restarting the second timer.

In one embodiment, when the second timer is in the running state, as a response to receiving a first-type data unit or as a response to transmitting the first-type data unit, restart the second timer.

In one embodiment, when the action of restarting the second timer occurs, the second timer is in the running state.

In one embodiment, the phrase of starting or restarting the second timer comprises: the second timer beginning its time-counting.

In one embodiment, the any first-type data unit comprises at least one bit.

In one embodiment, the any first-type data unit comprises at least one byte.

In one embodiment, the first-type data unit comprises a MAC SDU.

In one embodiment, the first-type data unit comprises a MAC SDU segment.

In one embodiment, the first-type data unit comprises a Radio Link Control (RLC) SDU.

In one embodiment, the first-type data unit comprises an RLC PDU.

In one embodiment, the action of maintaining a second timer comprises: as a response to transmitting a second-type data unit, starting or restarting the second timer.

In one embodiment, the action of maintaining a second timer comprises: as a response to receiving a second-type data unit or as a response to receiving a third-type data unit, starting or restarting the second timer.

In one embodiment, the second-type data unit belongs to a Dedicated Control Channel (DCCH) logical channel.

In one embodiment, the third-type data unit belongs to a CCCH logical channel.

In one embodiment, the second-type data unit comprises a MAC SDU.

In one embodiment, the second-type data unit comprises a MAC SDU segment.

In one embodiment, the third-type data unit comprises a MAC SDU.

In one embodiment, the third-type data unit comprises a MAC SDU segment.

In one embodiment, the action of maintaining a second timer comprises: receiving the first-type data unit or transmitting the first-type data unit in the RRC inactive state not being used for starting or restarting a dataInactivityTimer.

In one embodiment, the dataInactivityTimer is only running in the RRC connected state.

In one embodiment, the second timer is set up in the RRC inactive state; the dataInactivityTimer is set up in the RRC connected state.

In one embodiment, receiving the first-type data unit or transmitting the first-type data unit in the RRC inactive state is used for starting or restarting the second timer; upon reception of a MAC SDU belonging to any of the three of a Dedicated Traffic Channel (DTCH), a DCCH or a CCCH in the RRC connected state, starting or restarting the dataInactivityTimer.

In one embodiment, receiving the first-type data unit or transmitting the first-type data unit in the RRC inactive state is used for starting or restarting the second timer; upon transmission of a MAC SDU belonging to any of a DTCH or a DCCH in the RRC connected state, starting or restarting the dataInactivityTimer.

In one embodiment, whether to switch an RRC state is determined according to both a state of the first timer and a state of the second timer.

In one embodiment, the first timer is in a running state or is not in a running state.

In one embodiment, the second timer is in a running state or is not in a running state.

In one embodiment, since the first timer starts counting time and till a most recent stop of its time counting, the first timer is in a running state.

In one embodiment, since the first timer starts counting time and till a most recent expiration, the first timer is in the running state.

In one embodiment, while the first timer is counting time, the first timer is in the running state.

In one embodiment, since the first timer stops counting time and till a most recent start of its time counting, the first timer is not in a running state.

In one embodiment, since the first timer is expired and till a most recent start of its time counting, the first timer is not in the running state.

In one embodiment, since the second timer starts counting time and till a most recent stop of its time counting, the second timer is in a running state.

In one embodiment, since the second timer starts counting time and till a most recent expiration, the second timer is in the running state.

In one embodiment, while the second timer is counting time, the second timer is in the running state.

In one embodiment, since the second timer stops counting time and till a most recent start of its time counting, the second timer is not in a running state.

In one embodiment, since the second timer is expired and till a most recent start of its time counting, the second timer is not in the running state.

In one embodiment, the state of the first timer and the state of the second timer are used together to determine whether to switch the RRC state.

In one embodiment, any of the state of the first timer or the state of the second timer is not solely used to determine whether to switch the RRC state.

In one embodiment, only the state of the first timer is not used to determine whether to switch the RRC state.

In one embodiment, only the state of the second timer is not used to determine whether to switch the RRC state.

In one embodiment, when the second timer is not in a running state, as a response to that the first timer is expired, an RRC inactive state is switched to a first RRC state.

In one embodiment, the first RRC state is a candidate state in a first candidate state set.

In one embodiment, the first RRC state is the RRC idle state.

In one embodiment, the first RRC state is the RRC inactive state.

In one embodiment, the first RRC state is the RRC connected state.

In one embodiment, the first candidate state set comprises the RRC idle state.

In one embodiment, the first candidate state set comprises the RRC connected state.

In one embodiment, the first candidate state set comprises the RRC inactive state.

In one embodiment, when the second timer is not in a running state, as a response to that the first timer is expired, the RRC inactive state is switched to the RRC idle state.

In one embodiment, when the second timer is in the running state, that the first timer is expired does not trigger a switch from the RRC inactive state to the first RRC state.

In one embodiment, when the second timer is in the running state, that the first timer is expired does not trigger a switch from the RRC inactive state to the RRC idle state.

In one embodiment, when the second timer is in the running state, the first timer stays in the RRC state after being expired.

In one embodiment, when the second timer is in the running state, the first timer stays in the RRC inactive state after being expired.

In one embodiment, when the second timer is not in a running state, as a response to that the first timer is expired, the RRC inactive state is switched back to the RRC inactive state.

In one embodiment, if the first message comprises a RRCReestablishmentRequest, when the second timer is not in a running state, as a response to that the first timer is expired, the RRC inactive state is switched to the RRC connected state.

In one embodiment, when the first timer is not in the running state, that the second timer is expired does not trigger a switch from the RRC inactive state to the first RRC state.

In one embodiment, when the first timer is not in the running state, the second timer stays in the RRC inactive state after being expired.

In one embodiment, when the first timer is in the running state, as a response to that the second timer is expired, the RRC inactive state is switched to the first RRC state.

In one embodiment, when the first timer is in the running state, as a response to that the second timer is expired, the RRC inactive state is switched to the RRC idle state.

In one embodiment, while any of the first timer or the second timer is running, the first node is in the RRC inactive state.

In one embodiment, while any of the first timer or the second timer is running, the first node is in the SDT procedure.

In one embodiment, while neither the first timer nor the second timer is in the running state, the first node is in the first RRC state.

In one embodiment, while neither the first timer nor the second timer is in the running state, the first node is in the RRC idle state.

In one embodiment, while neither the first timer nor the second timer is in the running state, the first node is in the RRC connected state.

### Embodiment 1B

Embodiment 1B illustrates a flowchart of transmission of a first node according to one embodiment of the present application, as shown in FIG. 1B.

In Embodiment 1B, a first node 100B transmits a first message in step 101B, the first message comprising an RRC signaling; and maintains a first timer in step 102B; and in step 103B, as a response to that the first timer is expired, switches from an RRC inactive state to a first RRC state; herein, the action of maintaining a first timer comprises: as a response to that a number of first-type data unit(s) transmitted after a most recent start of the first timer exceeds a first threshold, restarting the first timer; if a second message is received, as a response to receiving the second message, stopping the first timer, the second message comprising an RRC signaling, and the second message being used as a response to the first message; the first RRC state is a candidate state in a first candidate state set, the first candidate state set comprising an RRC idle state; the first threshold is configurable, or, the first threshold is a positive integer greater than 1.

In one embodiment, the first message is transmitted through an air interface.

In one embodiment, the air interface includes an interface of radio signal transmission.

In one embodiment, the air interface includes an interface of radio signaling transmission.

In one embodiment, the air interface includes a Uu.

In one embodiment, the air interface includes a PC5.

In one embodiment, the first message comprises contents buffered in a Message A (MsgA).

In one embodiment, the first message comprises contents buffered in a Message 3 (Msg3).

In one embodiment, the first message belongs to a Random Access (RA) procedure.

In one embodiment, the first message is an Msg3 in a 4-step random access procedure.

In one embodiment, the first message is an MsgA in a 2-step random access procedure.

In one embodiment, a radio resource occupied by the first message is with Configured Grant (CG).

In one embodiment, the first message comprises a Medium Access Control (MAC) Protocol Data Unit (PDU).

In one embodiment, a MAC PDU comprises at least one MAC subPDU, the MAC subPDU comprising a MAC subheader, or the MAC subPDU comprising a MAC subheader and an SDU, or the MAC subPDU comprising a MAC subheader and a MAC Control Element (CE), or the MAC subPDU comprising a MAC subheader and padding.

In one embodiment, the first message only comprises at least partial bits in the first-type data unit.

In one embodiment, the first message comprises at least partial bits in the first-type data unit.

In one embodiment, the first message comprises an RRC signaling.

In one embodiment, the first message comprises an RRC signaling and at least partial bits in the first-type data unit.

In one embodiment, the first message comprises at least two MAC SDUs, the at least two MAC SDUs respectively comprising an RRC signaling and at least partial bits in the first-type data unit.

In one embodiment, the first message comprises a Buffer Status Report (BSR).

In one embodiment, an RRC signaling comprised by the first message belongs to a Common Control Channel (CCCH).

In one embodiment, an RRC signaling comprised by the first message belongs to a Signaling Radio Bearer 0 (SRB0).

In one embodiment, the first message comprises a RRCResumeRequest.

In one embodiment, the first message comprises a RRCResumeRequest1.

In one embodiment, when the first message comprises a RRCResumeRequest, a resumeIdentity field comprised by the first message comprises 24 bits; when the first message comprises a RRCResumeRequest1, a resumeIdentity field comprised by the first message comprises 40 bits.

In one embodiment, the first message comprises a resumeCause field.

In one embodiment, a name of a resumeCause comprised by the first message includes small data transmission (SDT).

In one embodiment, a resumeCause comprised by the first message is an SDT.

In one embodiment, a resumeCause comprised by the first message is a mobile originated (mo)-SDT.

In one embodiment, a resumeCause comprised by the first message is a mo-Short Message Service (SMS).

In one embodiment, a resumeCause comprised by the first message is an emergency.

In one embodiment, a resumeCause comprised by the first message is a mobile terminated (mt)-SDT.

In one embodiment, a resumeCause comprised by the first message is a mo-signalling.

In one embodiment, the first message comprises a RRCReestablishmentRequest.

In one embodiment, the first message comprises a ReestablishmentCause field.

In one embodiment, a ReestablishmentCause comprised by the first message is an SDT.

In one embodiment, the first timer is maintained in an RRC sublayer of the first node.

In one embodiment, the action of maintaining a first timer comprises: as a response to that a number of first-type data unit(s) transmitted after a most recent start of the first timer exceeds a first threshold, restarting the first timer.

In one embodiment, the phrase of first-type data unit(s) transmitted after a most recent start of the first timer comprises: the first-type data unit(s) transmitted through a MAC sublayer of the first node after a most recent start of the first timer.

In one embodiment, the phrase of first-type data unit(s) transmitted after a most recent start of the first timer comprises: the first-type data unit(s) being transmitted after a most recent start of the first timer.

In one embodiment, the first-type data unit(s) being transmitted only include the first-type data unit(s) being transmitted for the first time.

In one embodiment, the first-type data units being transmitted include the first-type data unit(s) being transmitted for the first time and the first-type data unit(s) being retransmitted.

In one embodiment, the phrase that the first-type data unit(s) being transmitted for the first time includes: the first-type data unit(s) that is(are) transmitted for the first time.

In one embodiment, the phrase that the first-type data unit(s) being transmitted for the first time includes: with K repetitions being configured per first-type data unit, the first-type data unit(s) being transmitted in a first transmission occasion of K transmission occasions.

In one embodiment, the phrase that the first-type data unit(s) being transmitted for the first time includes: a first signaling indicating time-frequency resources occupied by a first radio signal and a Modulation Coding Scheme (MCS) used by the first radio signal; a New Data Indicator (NDI) field of the first signaling is toggled, indicating the first-type data unit(s) being transmitted for the first time.

In one embodiment, the phrase that the first-type data unit(s) being retransmitted includes: the first-type data unit(s) that is(are) retransmitted after the transmission of the first-type data unit(s) has failed.

In one embodiment, the phrase that the first-type data unit(s) being retransmitted includes: with K repetitions being configured per first-type data unit, the first-type data unit(s) being transmitted in a transmission occasion of K transmission occasions other than a first transmission occasion.

In one embodiment, the phrase that the first-type data unit(s) being retransmitted includes: a first signaling indicating time-frequency resources occupied by a first radio signal and a Modulation Coding Scheme (MCS) used by the first radio signal; an NDI field of the first signaling is not toggled, indicating the first-type data unit(s) being retransmitted.

In one embodiment, the phrase of first-type data unit(s) transmitted after a most recent start of the first timer comprises: the first-type data unit(s) being transmitted or retransmitted after a most recent start of the first timer.

In one embodiment, the phrase of first-type data unit(s) transmitted after a most recent start of the first timer comprises: the first-type data unit(s) being received after a most recent start of the first timer.

In one embodiment, the phrase of first-type data unit(s) transmitted after a most recent start of the first timer comprises: the first-type data unit(s) being transmitted after a most recent start of the first timer and the first-type data unit(s) being received after the most recent start of the first timer.

In one embodiment, the phrase of first-type data unit(s) transmitted after a most recent start of the first timer comprises: the first-type data unit(s) being transmitted or retransmitted after a most recent start of the first timer and the first-type data unit(s) being received after the most recent start of the first timer.

In one embodiment, the phrase that a number of first-type data unit(s) transmitted after a most recent start of the first timer exceeds a first threshold comprises: the number of first-type data unit(s) transmitted after a most recent start of the first timer is greater than a first threshold.

In one embodiment, the phrase that a number of first-type data unit(s) transmitted after a most recent start of the first timer exceeds a first threshold comprises: the number of first-type data unit(s) transmitted after a most recent start of the first timer is equal to a first threshold.

In one embodiment, the phrase that a number of first-type data unit(s) transmitted after a most recent start of the first timer exceeds a first threshold comprises: the number of first-type data unit(s) transmitted after a most recent start of the first timer is no less than a first threshold.

In one embodiment, the first timer won't restart until the number of the first-type data unit(s) transmitted after a most recent start of the first timer and before the first timer expires exceeds the first threshold.

In one embodiment, a most recent start of the first timer includes one of a first start or a restart in a SDT procedure.

In one embodiment, the SDT procedure comprises activities from transmitting a first of all messages that comprises a random access procedure to which the first message belongs to receiving the second message.

In one embodiment, the SDT procedure comprises activities from initiating a random access procedure to which the first message belongs to receiving the second message.

In one embodiment, the SDT procedure comprises activities from transmitting the first message to receiving the second message.

In one embodiment, the any first-type data unit comprises at least one bit.

In one embodiment, the any first-type data unit comprises at least one byte.

In one embodiment, the first-type data unit comprises a MAC SDU.

In one embodiment, the first-type data unit comprises a MAC SDU segment.

In one embodiment, the first-type data unit comprises a Radio Link Control (RLC) SDU.

In one embodiment, the first-type data unit comprises an RLC PDU.

In one embodiment, the number of first-type data unit(s) transmitted after a most recent start of the first timer comprises Q1 byte(s); Q1 is 0, or 1, or is a positive integer greater than 1.

In one embodiment, the number of first-type data unit(s) transmitted after a most recent start of the first timer comprises Q2 MAC SDU(s); Q2 is 0, or 1, or is a positive integer greater than 1.

In one embodiment, the number of first-type data unit(s) transmitted after a most recent start of the first timer is expressed in Byte(s).

In one embodiment, the number of first-type data unit(s) transmitted after a most recent start of the first timer is expressed in bit(s).

In one embodiment, the number of first-type data unit(s) transmitted after a most recent start of the first timer is expressed in Byte/s.

In one embodiment, the number of first-type data unit(s) transmitted after a most recent start of the first timer is expressed in the number of MAC SDU(s).

In one embodiment, the first threshold is configurable.

In one embodiment, the first threshold is configured by the network.

In one embodiment, the first threshold is pre-configured.

In one embodiment, the first threshold is configured by a serving base station of the first node.

In one embodiment, the first threshold is configured through a higher layer signaling.

In one embodiment, the first threshold is configured through a System Information Block (SIB).

In one embodiment, the first threshold is configured through a SIB1.

In one embodiment, the first threshold is configured through an RRC signaling.

In one embodiment, the first threshold is carried in all or partial Information Elements (IEs) in an RRC signaling.

In one embodiment, the first threshold is carried in all or partial fields of an IE in an RRC signaling.

In one embodiment, the first threshold is a fixed value.

In one embodiment, the first threshold is 0.

In one embodiment, the first threshold is 1.

In one embodiment, the first threshold is a positive integer greater than 1.

In one embodiment, the first threshold is expressed in byte(s).

In one embodiment, the first threshold is expressed in bit(s).

In one embodiment, the first threshold is expressed in Byte/s.

In one embodiment, the first threshold is expressed in MAC SDU(s).

In one embodiment, when the action of restarting the first timer occurs, the first timer is in a running state.

In one embodiment, the phrase of restarting the first timer comprises: the first timer beginning its time-counting.

In one embodiment, since the first timer starts counting time and till a most recent stop of its time counting, the first timer is in a running state.

In one embodiment, since the first timer starts counting time and till a most recent expiration, the first timer is in the running state.

In one embodiment, while the first timer is counting time, the first timer is in the running state.

In one embodiment, since the first timer stops counting time and till a most recent start of its time counting, the first timer is not in the running state.

In one embodiment, since the first timer is expired and till a most recent start of its time counting, the first timer is not in the running state.

In one embodiment, the action of maintaining a first timer comprises: if a second message is received, as a response to receiving the second message, stopping the first timer.

In one embodiment, the second message is received through the air interface.

In one embodiment, the second message comprises an RRC signaling, and the second message is a response to the first message.

In one embodiment, the second message is received in the RRC sublayer of the first node.

In one embodiment, the second message comprises a higher-layer signaling.

In one embodiment, the second message comprises a RRCRelease.

In one embodiment, the second message comprises a RRCReject.

In one embodiment, the second message comprises a RRCResume.

In one embodiment, the second message comprises a RRCSetup.

In one embodiment, as a response to transmitting the first message, the second message is received.

In one embodiment, the first node is in the RRC inactive state after transmitting the first message and before receiving the second message.

In one embodiment, as a response to receiving the second message, stopping the first timer.

In one embodiment, the phrase of stopping the first timer comprises that: the first timer stops its time-counting.

In one embodiment, when receiving the second message, the first timer is in the running state.

In one embodiment, if the second message is not received before the first timer is expired, cancel receiving the second message.

In one embodiment, if the first timer is expired, cancel receiving the second message.

In one embodiment, when the first timer is not in the running state, cancel receiving the second message.

In one embodiment, while the first timer is not in a running state, the serving base station of the first node cancels transmitting the second message.

In one embodiment, as a response to that the first timer is expired, the first node switches from the RRC inactive state to a first RRC state.

In one embodiment, when the first timer is running, the first node is in the RRC inactive state.

In one embodiment, the first RRC state is a candidate state in a first candidate state set.

In one embodiment, the first RRC state is the RRC_IDLE state.

In one embodiment, the first RRC state is the RRC inactive state.

In one embodiment, the first RRC state is the RRC connected state.

In one embodiment, the first candidate state set comprises the RRC idle state.

In one embodiment, the first candidate state set comprises the RRC connected state.

In one embodiment, the first candidate state set comprises the RRC inactive state.

In one embodiment, as a response to that the first timer is expired, the first node switches from the RRC inactive state to the RRC idle state.

In one embodiment, as a response to that the first timer is expired, the first node switches from the RRC inactive state back to the RRC inactive state.

In one embodiment, if the first message comprises a RRCReestablishmentRequest, as a response to that the first timer is expired, the first node switches from the RRC inactive state to the RRC connected state.

### Embodiment 2

Embodiment 2 illustrates a schematic diagram of a network architecture according to one embodiment of the present application, as shown in FIG. 2. FIG. 2 illustrates a network architecture 200 of NR 5G, Long-Term Evolution (LTE), and Long-Term Evolution Advanced (LTE-A) systems. The NR 5G or LTE, or LTE-A network architecture 200 may be called a 5G System/Evolved Packet System (5GS/EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server/Unified Data Management (HSS/UDM) 220 and an Internet Service 230. The 5GS/EPS may be interconnected with other access networks. For simple description, the entities/interfaces are not shown. As shown in FIG. 2, the 5GS/EPS provides packet switching services. Those skilled in the art will find it easy to understand that various concepts presented throughout the present application can be extended to networks providing circuit switching services or other cellular networks. The NG-RAN comprises an NR node B (gNB) 203 and other gNBs 204. The gNB 203 provides UE 201-oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. In NTN, the gNB 203 can be a satellite, an aircraft or a terrestrial base station relayed through the satellite. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, vehicle-mounted equipment, vehicle-mounted communication units, wearable equipment, or any other devices having similar functions. Those skilled in the art also can call the UE 201a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an S1/NG interface. The 5G-CN/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises operator-compatible IP services, specifically including Internet, Intranet, IP Multimedia Subsystem (IMS) and Packet Switching (PS) Streaming services.

In one embodiment, the UE 201 corresponds to a first node in the present application.

In one embodiment, the NR Node B203 corresponds to a second node in the present application.

In one embodiment, the gNB203 is a Macro Cell base station.

In one embodiment, the gNB203 is a Micro Cell base station.

In one embodiment, the gNB203 is a Pico Cell base station.

In one embodiment, the gNB203 is a Femtocell.

In one embodiment, the gNB203 is a base station supporting large time-delay difference.

In one embodiment, the gNB203 is a flight platform.

In one embodiment, the gNB203 is satellite equipment.

In one embodiment, the gNB203 is a piece of test equipment (e.g., a transceiving device simulating partial functions of the base station, or a signaling test instrument).

In one embodiment, a radio link from the UE201 to the gNB203 is an uplink, the uplink being used for performing uplink transmission.

In one embodiment, a radio link from the gNB203 to the UE201 is a downlink, the downlink being used for performing downlink transmission.

In one embodiment, a radio link between the UE201 and the UE241 is a sidelink, the sidelink being used for performing sidelink transmission.

In one embodiment, the UE201 and the gNB203 are connected by a Uu air interface.

In one embodiment, the UE 201 and the UE 241 are connected by a PC5 air interface.

### Embodiment 3

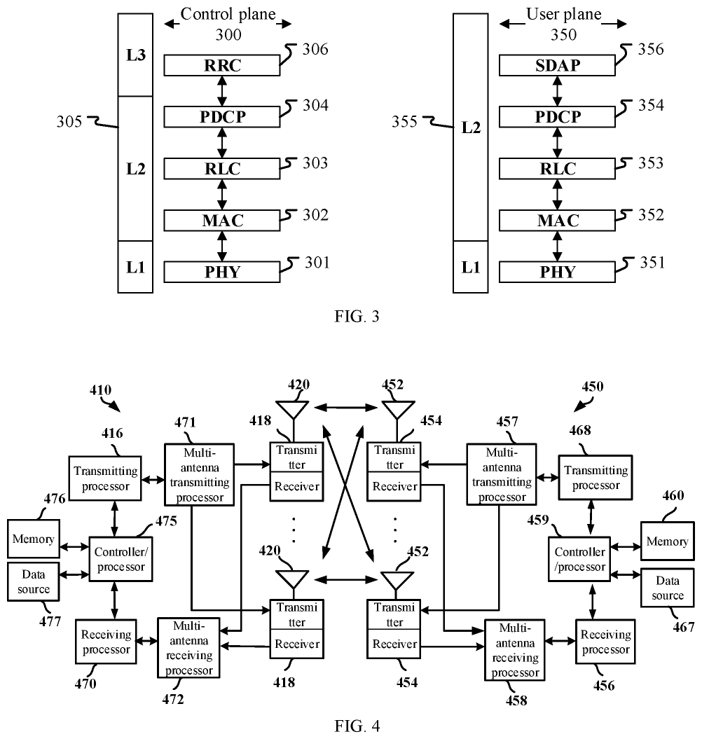

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 of a UE and a gNB is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between the UE and the gNB via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the gNBs of the network side. The PDCP sublayer 304 provides data encryption and integrity protection, and also support for handover of a UE between gNBs. The RLC sublayer 303 provides segmentation and reassembling of a packet, retransmission of a lost packet through ARQ, and detection of duplicate packets and protocol errors. The MAC sublayer 302 provides mappings between a logical channel and a transport channel as well as multiplexing of logical channel ID. The MAC sublayer 302 is also responsible for allocating between UEs various radio resources (i.e., resource block) in a cell. The MAC sublayer 302 is also in charge of Hybrid Automatic Repeat Request (HARQ) operation. In the control plane 300, The Radio Resource Control (RRC) sublayer 306 in the L3 layer is responsible for acquiring radio resources (i.e., radio bearer) and configuring the lower layer using an RRC signaling between the gNB and the UE. The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between Quality of Service (QoS) streams and a Data Radio Bearer (DRB), so as to support diversified traffics. The radio protocol architecture of UE in the user plane 350 may comprise all or part of protocol sublayers of a SDAP sublayer 356, a PDCP sublayer 354, a RLC sublayer 353 and a MAC sublayer 352 in L2. Although not described in FIG. 3, the UE may comprise several higher layers above the L2 355, such as a network layer (i.e., IP layer) terminated at a P-GW of the network side and an application layer terminated at the other side of the connection (i.e., a peer UE, a server, etc.).

In one embodiment, entities of multiple sublayers of the control plane in FIG. 3 form a Signaling Radio Bearer (SRB) vertically.

In one embodiment, entities of multiple sublayers of the control plane in FIG. 3 form a Data Radio Bearer (DRB) vertically.

In one embodiment, the radio protocol architecture in FIG. 3 is applicable to a first node in the present application.

In one embodiment, the radio protocol architecture in FIG. 3 is applicable to a second node in the present application.

In one embodiment, the first message in the present application is generated by the MAC302 or the MAC352.

In one embodiment, the first message in the present application is generated by the RRC306.

In one embodiment, the second message in the present application is generated by the MAC302 or the MAC352.

In one embodiment, the second message in the present application is generated by the RRC306.

In one embodiment, the third message in the present application is generated by the RRC306.

In one embodiment, the first data unit set in the present application is generated by the MAC302 or the MAC352.

In one embodiment, the L2 305 or 355 belongs to a higher layer.

In one embodiment, the RRC sublayer 306 in the L3 belongs to a higher layer.

### Embodiment 4

Embodiment 4 illustrates a schematic diagram of hardcore modules in a communication device according to one embodiment of the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a data source 477, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network or from a data source 477 is provided to the controller/processor 475. The core network and data source 477 represents all protocol layers above the L2 layer. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping of signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In a transmission from the second communication device 410 to the first communication device 450, the controller/processor 459 provides de-multiplexing between a transport channel and a logical channel, packet reassembling, decrypting, header decompression, control signal processing so as to recover a higher-layer packet from the second communication device 410. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device 450. The higher-layer packet coming from the controller/processor 475 may be provided to the core network, or all protocol layers above the L2, or, various control signals can be provided to the core network or L3 for processing.

In one embodiment, the first communication device 450 comprises at least one processor and at least one memory, the at least one memory comprises computer program codes; the at least one memory and the computer program codes are configured to be used in collaboration with the at least one processor. The first communication device 450 at least: maintains a first timer, and maintains a second timer; and transmits a first message, the first message comprising an RRC signaling; and determines whether to switch an RRC state according to both a state of the first timer and a state of the second timer; herein, the action of maintaining a first timer comprises: along with the first message, starting the first timer; the action of maintaining a second timer comprises: as a response to receiving a first-type data unit or as a response to transmitting the first-type data unit, starting or restarting the second timer; the action of determining whether to switch an RRC state according to both a state of the first timer and a state of the second timer comprises: when the second timer is not in a running state, as a response to that the first timer is expired, switching from an RRC inactive state to a first RRC state, or when the second timer is in the running state, that the first timer is expired not triggering a switch from the RRC inactive state to the first RRC state; the first RRC state is a candidate state in a first candidate state set, the first candidate state set comprising an RRC idle state.

In one embodiment, the first communication device 450 comprises a memory that stores a computer readable instruction program, the computer readable instruction program generates actions when executed by at least one processor, which include: maintaining a first timer; and transmitting a first message, the first message comprising an RRC signaling; and maintaining a first timer, and maintaining a second timer; and transmitting a first message, the first message comprising an RRC signaling; and determining whether to switch an RRC state according to both a state of the first timer and a state of the second timer; herein, the action of maintaining a first timer comprises: along with the first message, starting the first timer; the action of maintaining a second timer comprises: as a response to receiving a first-type data unit or as a response to transmitting the first-type data unit, starting or restarting the second timer; the action of determining whether to switch an RRC state according to both a state of the first timer and a state of the second timer comprises: when the second timer is not in a running state, as a response to that the first timer is expired, switching from an RRC inactive state to a first RRC state, or when the second timer is in the running state, that the first timer is expired not triggering a switch from the RRC inactive state to the first RRC state; the first RRC state is a candidate state in a first candidate state set, the first candidate state set comprising an RRC idle state.

In one embodiment, the first communication device 450 comprises at least one processor and at least one memory, the at least one memory comprises computer program codes; the at least one memory and the computer program codes are configured to be used in collaboration with the at least one processor. The first communication device 450 at least: maintains a first timer; and transmits a first message, the first message comprising an RRC signaling; and as a response to that the first timer is expired, switches from an RRC inactive state to a first RRC state; herein, the action of maintaining a first timer comprises: as a response to that a number of first-type data unit(s) transmitted after a most recent start of the first timer exceeds a first threshold, restarting the first timer; if a second message is received, as a response to receiving the second message, stopping the first timer, the second message comprising an RRC signaling, and the second message being used as a response to the first message; the first RRC state is a candidate state in a first candidate state set, the first candidate state set comprising an RRC idle state; the first threshold is configurable, or, the first threshold is a positive integer greater than 1.

In one embodiment, the first communication device 450 comprises a memory that stores a computer readable instruction program, the computer readable instruction program generates actions when executed by at least one processor, which include: maintaining a first timer; and transmitting a first message, the first message comprising an RRC signaling; and as a response to that the first timer is expired, switching from an RRC inactive state to a first RRC state; herein, the action of maintaining a first timer comprises: as a response to that a number of first-type data unit(s) transmitted after a most recent start of the first timer exceeds a first threshold, restarting the first timer; if a second message is received, as a response to receiving the second message, stopping the first timer, the second message comprising an RRC signaling, and the second message being used as a response to the first message; the first RRC state is a candidate state in a first candidate state set, the first candidate state set comprising an RRC idle state; the first threshold is configurable, or, the first threshold is a positive integer greater than 1.

In one embodiment, the second communication device 410 comprises at least one processor and at least one memory, the at least one memory comprises computer program codes; the at least one memory and the computer program codes are configured to be used in collaboration with the at least one processor. The second communication device 410 at least: receives a first message, the first message comprising an RRC signaling; a state of a first timer and a state of a second timer are used together for determining whether to switch an RRC state; herein, the first timer is maintained, and the second timer is maintained; the first timer being maintained comprises: along with the first message, the first timer being started; the second timer being maintained comprises: as a response to receiving a first-type data unit or as a response to transmitting the first-type data unit, the second timer being started or restarted; that a state of a first timer and a state of a second timer are used together for determining whether to switch an RRC state comprises: when the second timer is not in a running state, as a response to that the first timer is expired, an RRC inactive state being switched to a first RRC state, or when the second timer is in the running state, that the first timer is expired not triggering a switch from the RRC inactive state to the first RRC state; the first RRC state is a candidate state in a first candidate state set, the first candidate state set comprising an RRC idle state.

In one embodiment, the second communication device 410 comprises a memory that stores a computer readable instruction program, the computer readable instruction program generates actions when executed by at least one processor, which include: receiving a first message, the first message comprising an RRC signaling; a state of a first timer and a state of a second timer being used together for determining whether to switch an RRC state; herein, the first timer is maintained, and the second timer is maintained; the first timer being maintained comprises: along with the first message, the first timer being started; the second timer being maintained comprises: as a response to receiving a first-type data unit or as a response to transmitting the first-type data unit, the second timer being started or restarted; that a state of a first timer and a state of a second timer are used together for determining whether to switch an RRC state comprises: when the second timer is not in a running state, as a response to that the first timer is expired, an RRC inactive state being switched to a first RRC state, or when the second timer is in the running state, that the first timer is expired not triggering a switch from the RRC inactive state to the first RRC state; the first RRC state is a candidate state in a first candidate state set, the first candidate state set comprising an RRC idle state.

In one embodiment, the second communication device 410 comprises at least one processor and at least one memory, the at least one memory comprises computer program codes; the at least one memory and the computer program codes are configured to be used in collaboration with the at least one processor. The second communication device 410 at least: receives a first message, the first message comprising an RRC signaling; herein, a first timer is maintained; as a response to that the first timer is expired, an RRC inactive state is switched to a first RRC state; the first timer being maintained comprises: as a response to that a number of first-type data unit(s) transmitted after a most recent start of the first timer exceeds a first threshold, the first timer being restarted; if a second message is received, as a response to receiving the second message, the first timer being stopped, the second message comprising an RRC signaling, and the second message being used as a response to the first message; the first RRC state is a candidate state in a first candidate state set, the first candidate state set comprising an RRC idle state; the first threshold is configurable, or, the first threshold is a positive integer greater than 1.

In one embodiment, the second communication device 410 comprises a memory that stores a computer readable instruction program, the computer readable instruction program generates actions when executed by at least one processor, which include: receiving a first message, the first message comprising an RRC signaling; herein, a first timer is maintained; as a response to that the first timer is expired, an RRC inactive state is switched to a first RRC state; the first timer being maintained comprises: as a response to that a number of first-type data unit(s) transmitted after a most recent start of the first timer exceeds a first threshold, the first timer being restarted; if a second message is received, as a response to receiving the second message, the first timer being stopped, the second message comprising an RRC signaling, and the second message being used as a response to the first message; the first RRC state is a candidate state in a first candidate state set, the first candidate state set comprising an RRC idle state; the first threshold is configurable, or, the first threshold is a positive integer greater than 1.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a relay node.

In one embodiment, the second communication device 410 is a base station.

In one embodiment, the second communication device 410 is a relay node.

In one embodiment, at least one of the antenna 452, the transmitter 454, the multi-antenna transmitting processor 457, the transmitting processor 468 or the controller/processor 459 is used for transmitting a first message in the present application.

In one embodiment, at least one of the antenna 420, the receiver 418, the multi-antenna receiving processor 472, the receiving processor 470 or the controller/processor 475 is used for receiving a first message in the present application.

In one embodiment, at least one of the antenna 420, the transmitter 418, the multi-antenna transmitting processor 471, the transmitting processor 416 or the controller/processor 475 is used for transmitting a second message in the present application.

In one embodiment, at least one of the antenna 452, the receiver 454, the multi-antenna receiving processor 458, the receiving processor 456 or the controller/processor 459 is used for receiving a second message in the present application.

In one embodiment, at least one of the antenna 420, the transmitter 418, the multi-antenna transmitting processor 471, the transmitting processor 416 or the controller/processor 475 is used for transmitting a third message in the present application.

In one embodiment, at least one of the antenna 452, the receiver 454, the multi-antenna receiving processor 458, the receiving processor 456 or the controller/processor 459 is used for receiving a third message in the present application.

In one embodiment, at least one of the antenna 452, the receiver 454, the multi-antenna receiving processor 458, the receiving processor 456 or the controller/processor 459 is used for receiving a first data unit set in the present application.

### Embodiment 5A

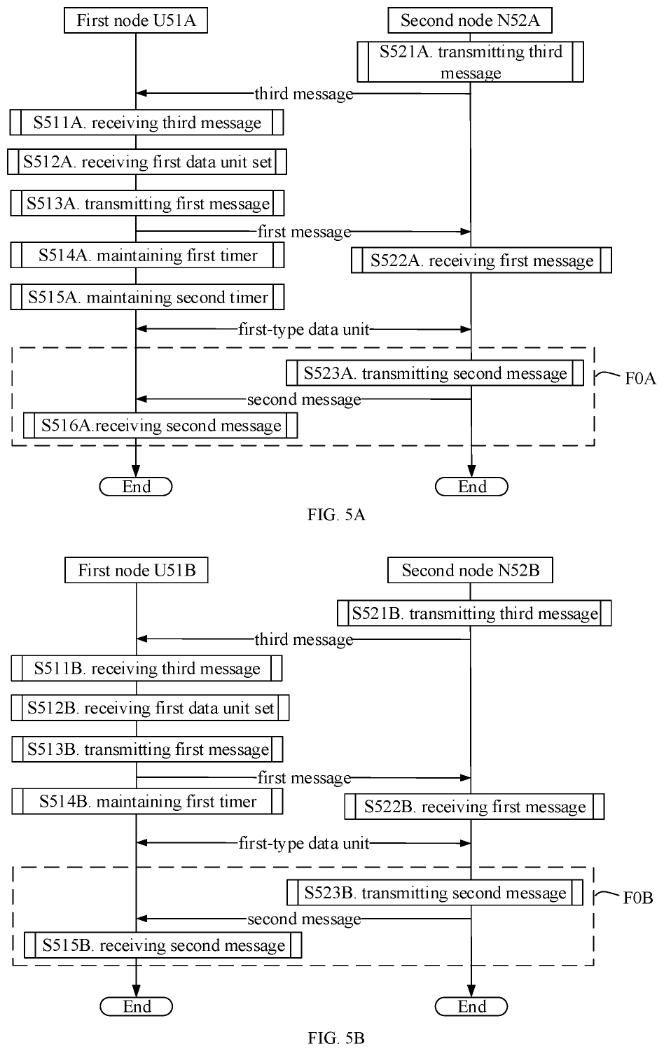

Embodiment 5A illustrates a flowchart of radio signal transmission according to one embodiment of the present application, as shown in FIG. 5A. In FIG. 5A, a first node U51A and a second node N52A are in communication via a radio interface. It should be particularly noted that the sequence illustrated herein does not set any limit to the signal transmission order or implementation order in the present application. The step F0A in the dotted-line box is optional.

The first node U51A receives a third message in step S511A; receives a first data unit set in step S512A; transmits a first message in step S513A; maintains a first timer in step S514A; and maintains a second timer in step S515A; and receives a second message in step S516A. It should be particularly noted that since the action of maintaining a first timer respectively comprise starting or stopping the first timer; and the action of maintaining a second timer respectively comprise starting, restarting or stopping the second timer, the step S514A and the step S515A respectively comprise multiple actions, where in specific implementations of these steps, an action in the step S514A can be earlier than an action in the step S515A, or an action in the step S514A can be later than an action in the step S515A.

The second node N52A transmits a third message in step S521A; receives a first message in step S522A; and transmits a second message in step S523A.

In Embodiment 5A, maintaining a first timer, and maintaining a second timer; and transmitting a first message, the first message comprising an RRC signaling; and determining whether to switch an RRC state according to both a state of the first timer and a state of the second timer; herein, the action of maintaining a first timer comprises: along with the first message, starting the first timer; the action of maintaining a second timer comprises: as a response to receiving a first-type data unit or as a response to transmitting the first-type data unit, starting or restarting the second timer; the action of determining whether to switch an RRC state according to both a state of the first timer and a state of the second timer comprises: when the second timer is not in a running state, as a response to that the first timer is expired, switching from an RRC inactive state to a first RRC state, or when the second timer is in the running state, that the first timer is expired not triggering a switch from the RRC inactive state to the first RRC state; the first RRC state is a candidate state in a first candidate state set, the first candidate state set comprising an RRC idle state; when the first timer is not in a running state, as a response to that the second timer is expired, the first timer switches from the RRC inactive state to the first RRC state; when the first timer is in the running state, that the second timer is expired does not trigger a switch from the RRC inactive state to the first RRC state; as a response to that the second timer is expired, conveying a first indication from a MAC sublayer to upper layer(s); herein, the second timer is maintained in the MAC sublayer; the first timer is maintained in an RRC sublayer; receiving a third message; herein, a time of receiving the third message is earlier than a time of transmitting the first message; the third message enables a first radio bearer set to be transmitted in the RRC inactive state; any first-type data unit belongs to a radio bearer in the first radio bearer set; receiving a first data unit set after receiving the third message and before transmitting the first message; herein, a data volume in the first data unit set is no larger than a first threshold; any data unit in the first data unit set belongs to the first-type data unit; the first node is in the RRC inactive state when transmitting the first message; if a second message is received, and the first timer is in the running state, as a response to receiving the second message, stopping the first timer; herein, the second message comprises an RRC signaling, and the second message is a response to the first message; the second message indicates the RRC state of the first node.

In one embodiment, the first node U51A transmits the first-type data unit after the step S513A and before the step S516A.

In one embodiment, the first node U51A receives the first-type data unit after the step S513A and before the step S516A.

In one embodiment, the first node U51A transmits the first-type data unit and receives the first-type data unit after the step S513A and before the step S516A.

In one embodiment, a third message is received through an air interface.

In one embodiment, the third message is received in the RRC sublayer of the first node.

In one embodiment, the third message comprises an RRC signaling.

In one embodiment, the third message comprises a RRCRelease.

In one embodiment, the third message comprises a RRCRelease, the RRCRelease comprising a SuspendConfig field; the third message indicates that the first node is in the RRC inactive state.

In one embodiment, the third message comprises configured grant radio resources occupied by the first message.

In one embodiment, the third message indicates that the first node enters into the RRC inactive state.

In one embodiment, the third message indicates that the first node switches from the RRC connected state to the RRC inactive state.

In one embodiment, the third message indicates that the first node switches from the RRC inactive state back to the RRC inactive state.

In one embodiment, the third message indicates that the first node switches from the RRC idle state to the RRC inactive state.

In one embodiment, when the third message indicates that the first node switches from the RRC connected state to the RRC inactive state, the first timer is set up.

In one embodiment, when the third message indicates that the first node switches from the RRC connected state to the RRC inactive state, the second timer is set up.

In one embodiment, when the third message indicates that the first node switches from the RRC idle state to the RRC inactive state, the first timer is set up.

In one embodiment, when the third message indicates that the first node switches from the RRC idle state to the RRC inactive state, the second timer is set up.

In one embodiment, a time of receiving the third message is earlier than a time of transmitting the first message.

In one embodiment, a time of receiving the third message is earlier than a time of initiating a random access procedure to which the first message belongs.

In one embodiment, a time of receiving the third message is earlier than a time of transmitting an Msg1 comprised in a random access procedure to which the first message belongs.

In one embodiment, a time of receiving the third message is earlier than a time of transmitting an MsgA comprised in a random access procedure to which the first message belongs.

In one embodiment, the third message enables a first radio bearer set to be transmitted in the RRC inactive state.

In one embodiment, the phrase that the third message enables a first radio bearer set to be transmitted in the RRC inactive state comprises that: the third message indicates that the first radio bearer set is to be transmitted in the RRC inactive state, with a first condition set being satisfied.

In one embodiment, the first condition set comprises at least one condition.

In one embodiment, the first condition set only comprises that a data volume in the first radio bearer set buffered before transmitting the first message is no larger than a first threshold.

In one embodiment, the first condition set only comprises that a data volume in the first radio bearer set buffered before transmitting the first message is smaller than a first threshold.

In one embodiment, the first condition set comprises that a data volume in the first radio bearer set transmitted after transmitting the first message and before receiving the second message is no larger than a first threshold.

In one embodiment, the first condition set comprises that a data volume in the first radio bearer set transmitted after transmitting the first message and before receiving the second message is smaller than a first threshold.

In one embodiment, the first condition set comprises being uplink synchronized with a receiver of the first message before transmitting the first message.

In one embodiment, the first condition set comprises that a Reference Signal Received Power (RSRP) of the receiver of the first message measured by a transmitter of the first message is no smaller than a second threshold; the second threshold is configured by the network or pre-configured.

In one embodiment, the first condition set comprises at least a first one of the following three conditions: a data volume in the first radio bearer set buffered before transmitting the first message being no larger than a first threshold; being uplink synchronized with a receiver of the first message before transmitting the first message; or an RSRP of the receiver of the first message measured by a transmitter of the first message being no smaller than a second threshold.

In one embodiment, the first condition set comprises at least a first one of the following three conditions: a data volume in the first radio bearer set buffered before transmitting the first message being smaller than a first threshold; being uplink synchronized with a receiver of the first message before transmitting the first message; or an RSRP of the receiver of the first message measured by a transmitter of the first message being no smaller than a second threshold.

In one embodiment, when each condition in the first condition set is satisfied, the first radio bearer set is transmitted in the RRC inactive state.

In one embodiment, when any condition in the first condition set is not satisfied, the first radio bearer set is transmitted in the RRC connected state.

In one embodiment, a name of a field comprised by the third message includes SDT.

In one embodiment, the third message indicates the first radio bearer set; the first radio bearer set comprises at least one RB.

In one embodiment, the third message comprises a first radio bearer identifier set, the first radio bearer identifier set comprising at least one radio bearer identifier; any radio bearer identifier in the first radio bearer identifier set indicates a radio bearer in the first radio bearer set.

In one embodiment, any radio bearer in the first radio bearer set is a Data Radio Bearer (DRB).

In one embodiment, any radio bearer in the first radio bearer set includes a Packet Data Convergence Protocol (PDCP) bearer.

In one embodiment, any radio bearer in the first radio bearer set includes an RLC bearer.

In one embodiment, any radio bearer in the first radio bearer set includes an RLC channel.

In one embodiment, any first-type data unit belongs to a radio bearer in the first radio bearer set.

In one embodiment, any first-type data unit is transmitted through a radio bearer in the first radio bearer set.

In one embodiment, receiving a first data unit set after receiving the third message and before transmitting the first message.

In one embodiment, after receiving the third message and before initiating a random access procedure to which the first message belongs, the first data unit set is received.

In one embodiment, after receiving the third message and before transmitting an Msg1 comprised by a random access procedure to which the first message belongs, the first data unit set is received.

In one embodiment, after receiving the third message and before transmitting an MsgA comprised by a random access procedure to which the first message belongs, the first data unit set is received.

In one embodiment, after receiving the third message and before initiating a SDT procedure to which the first message belongs, the first data unit set is received.

In one embodiment, the first message is a first of all messages comprising the first-type data unit that is transmitted after receiving the third message.

In one embodiment, the first data unit set is received from an upper layer of the first node; the upper layer is a NAS.

In one embodiment, the first data unit set is received through an air interface.

In one embodiment, the first data unit set comprises at least one data unit.

In one embodiment, any data unit in the first data unit set belongs to the first-type data unit.

In one embodiment, any data unit in the first data unit set belongs to one radio bearer in the first radio bearer set.

In one embodiment, a data volume in the first data unit set is no larger than a first threshold.

In one embodiment, a data volume in the first data unit set is smaller than the first threshold.

In one embodiment, the data volume in the first data unit set comprises at least one bit.

In one embodiment, the data volume in the first data unit set comprises at least one byte.

In one embodiment, the first data unit set comprises all currently-buffered data units.

In one embodiment, the first data unit set comprises all data units currently buffered in a MAC sublayer.

In one embodiment, the first data unit set comprises all data units currently buffered in a MAC sublayer and an RLC sublayer.

In one embodiment, the first data unit set comprises all data units currently buffered in a MAC sublayer, an RLC sublayer and a PDCP sublayer.

In one embodiment, the data volume in the first data unit set comprises values obtained by bit numbers of all bits comprised by the first data unit set being divided by 8.

In one embodiment, the data volume in the first data unit set is expressed in byte(s).

In one embodiment, the first threshold is configured by the network.

In one embodiment, the first threshold is pre-configured.

In one embodiment, the first threshold is a fixed value.

In one embodiment, the first threshold is specified.

In one embodiment, the first threshold is configured by a System Information Block (SIB).

In one embodiment, the first threshold is configured by a SIB1.

In one embodiment, the first threshold is configured by an RRC signaling.

In one embodiment, the first threshold is carried in all or partial Information Elements (IEs) in an RRC signaling.

In one embodiment, the first threshold is carried in all or partial fields of an IE in an RRC signaling.

In one embodiment, the first threshold is expressed in byte(s).

In one embodiment, as a response to receiving the first data unit set, transmitting the first message.

In one embodiment, as a response to receiving the first data unit set, triggering a random access procedure to which the first message belongs.

In one embodiment, as a response to receiving the first data unit set, triggering a SDT procedure.

In one embodiment, the first node is in the RRC inactive state when transmitting the first message; the first message comprises at least partial bits in at least one first-type data unit comprised by the first data unit set.

In one embodiment, when the first timer is not in the running state, as a response to that the second timer is expired, the RRC inactive state is switched to the first RRC state.

In one embodiment, when the first timer is not in the running state, as a response to that the second timer is expired, the RRC inactive state is switched to the RRC idle state.

In one embodiment, when the first timer is not in a running state, as a response to that the second timer is expired, the RRC inactive state is switched back to the RRC inactive state.

In one embodiment, if the first message comprises a RRCReestablishmentRequest, when the first timer is not in the running state, as a response to that the second timer is expired, the RRC inactive state is switched to the RRC connected state.

In one embodiment, when the first timer is in the running state, that the second timer is expired does not trigger a switch from the RRC inactive state to the first RRC state.

In one embodiment, when the first timer is in the running state, that the second timer is expired does not trigger a switch from the RRC inactive state to the RRC idle state.

In one embodiment, when the first timer is in the running state, the second timer stays in the RRC state after being expired.

In one embodiment, when the first timer is in the running state, the second timer stays in the RRC inactive state after being expired.

In one embodiment, as a response to the second timer being expired, a first indication is conveyed from a MAC sublayer of the first node to an upper layer of the first node; the upper layer is an RRC sublayer.

In one embodiment, the first indication is used to indicate that the second timer is not in the running state.

In one embodiment, upon reception of the first indication by the RRC sublayer of the first node, if the first timer is expired, the first node switches from the RRC inactive state to the first RRC state.

In one embodiment, upon reception of the first indication by the RRC sublayer of the first node, as a response to that the first timer is expired, the first node switches from the RRC inactive state to the first RRC state.

In one embodiment, when the first indication is not received by an RRC sublayer of the first node, the second timer is in the running state.

In one embodiment, when the first indication is not received by the RRC sublayer of the first node, that the first timer is expired does not trigger a switch from the RRC inactive state to the first RRC state.

In one embodiment, when the first indication is not received by the RRC sublayer of the first node, if the first timer is expired, the first node stays in the RRC state.

In one embodiment, when the first indication is not received by the RRC sublayer of the first node, if the first timer is expired, the first node stays in the RRC inactive state.

In one embodiment, the action of maintaining a first timer comprises: if a second message is received, and the first timer is in the running state, as a response to receiving the second message, stopping the first timer.

In one embodiment, the phrase of stopping the first timer comprises that: the first timer stops its time-counting.

In one embodiment, upon reception of the second message, at least one of the first timer or the second timer is in a running state.

In one embodiment, if the first timer is not in the running state and the second timer is expired, cancel receiving the second message.

In one embodiment, if the second timer is not in the running state and the first timer is expired, cancel receiving the second message.

In one embodiment, if any of the first timer or the second timer is in a running state, listen over the second message per downlink slot.

In one embodiment, while the first timer is not in a running state and the second timer is not in a running state, the serving base station of the first node cancels transmitting the second message.

In one embodiment, the second message is received through the air interface.

In one embodiment, the second message comprises an RRC signaling, and the second message is a response to the first message.

In one embodiment, the second message is received in the RRC sublayer of the first node.

In one embodiment, the second message comprises a higher-layer signaling.

In one embodiment, the second message comprises a RRCRelease.

In one embodiment, the second message comprises a RRCReject.

In one embodiment, the second message comprises a RRCResume.

In one embodiment, the second message comprises a RRCSetup.

In one embodiment, as a response to transmitting the first message, the second message is received.

In one embodiment, the second message comprises a RRCRelease, and the RRCRelease does not comprise a SuspendConfig field; the second message indicates that the RRC state of the first node is the RRC idle state.

In one embodiment, the second message comprises a RRCRelease, and the RRCRelease comprises a SuspendConfig field; the second message indicates that the RRC state of the first node is the RRC inactive state.

In one embodiment, the second message comprises a RRCReject; the second message indicates that the RRC state of the first node is the RRC idle state.

In one embodiment, the second message comprises a RRCResume; the second message indicates that the RRC state of the first node is an RRC connected state.

In one embodiment, the second message comprises a RRCSetup; the second message indicates that the RRC state of the first node is the RRC connected state.

In one embodiment, the second message comprises a RRCReestablishment; the second message indicates that the RRC state of the first node is the RRC connected state.

In one embodiment, when the second message indicates that the RRC state of the first node is the RRC connected state, the first timer is released.

In one embodiment, when the second message indicates that the RRC state of the first node is the RRC connected state, the second timer is released.

In one embodiment, when the second message indicates that the RRC state of the first node is the RRC idle state, the first timer is released.

In one embodiment, when the second message indicates that the RRC state of the first node is the RRC idle state, the second timer is released.

In one embodiment, the first node is in the RRC inactive state after transmitting the first message and before receiving the second message.

In one embodiment, the first node is in the RRC inactive state from after transmitting the first message till the first timer is expired; when the first timer is expired, the second timer is not in the running state.

In one embodiment, the first node is in the RRC inactive state after transmitting the first message till the second timer is expired; when the second timer is expired, the first timer is not in the running state.

### Embodiment 5B

Embodiment 5B illustrates a flowchart of radio signal transmission according to one embodiment of the present application, as shown in FIG. 5B. In FIG. 5B, a first node U51B and a second node N52B are in communication via a radio interface. It should be particularly noted that the sequence illustrated herein does not set any limit to the signal transmission order or implementation order in the present application. The step FOB in the dotted-line box is optional.

The first node U51B receives a third message in step S511B; receives a first data unit set in step S512B; transmits a first message in step S513B; maintains a first timer in step S514B; and receives a second message in step S515B.

The second node N52B transmits a third message in step S521B; receives a first message in step S522B; and transmits a second message in step S523B.

In Embodiment 5B, maintaining a first timer; transmitting a first message, the first message comprising an RRC signaling; and as a response to that the first timer is expired, switching from an RRC inactive state to a first RRC state; herein, the action of maintaining a first timer comprises: as a response to that a number of first-type data unit(s) transmitted after a most recent start of the first timer exceeds a first threshold, restarting the first timer; if a second message is received, as a response to receiving the second message, stopping the first timer, the second message comprising an RRC signaling, and the second message being used as a response to the first message; the first RRC state is a candidate state in a first candidate state set, the first candidate state set comprising an RRC idle state; the first threshold is configurable, or, the first threshold is a positive integer greater than 1; as a response to that a number of first-type data unit(s) transmitted after a most recent start of the first timer exceeds a first threshold, conveying a first indication from a MAC sublayer to upper layer(s); herein, the first indication is used for triggering the action of restarting the first timer, where the number of the first-type data unit(s) is calculated in the MAC sublayer; the first timer is maintained in an RRC sublayer; receiving a third message; herein, a time of receiving the third message is earlier than a time of transmitting the first message; the third message enables a first radio bearer set to be transmitted in the RRC inactive state; any first-type data unit belongs to a radio bearer in the first radio bearer set; receiving a first data unit set after receiving the third message and before transmitting the first message; herein, a data volume in the first data unit set is no larger than a first threshold; any data unit in the first data unit set belongs to the first-type data unit; the first node is in the RRC inactive state when transmitting the first message; the second message indicating an RRC state of the first node.

In one embodiment, the first node U51B transmits the first-type data unit after the step S513B and before the step S515B.

In one embodiment, the first node U51B receives the first-type data unit after the step S513B and before the step S515B.

In one embodiment, the first node U51B transmits the first-type data unit and receives the first-type data unit after the step S513B and before the step S515B.

In one embodiment, a third message is received through an air interface.

In one embodiment, the third message is received in the RRC sublayer of the first node.

In one embodiment, the third message comprises an RRC signaling.

In one embodiment, the third message comprises a RRCRelease.

In one embodiment, the third message comprises a RRCRelease, the RRCRelease comprising a SuspendConfig field; the third message indicates that the first node is in the RRC inactive state.

In one embodiment, the third message comprises configured grant radio resources occupied by the first message.

In one embodiment, the third message indicates that the first node enters into the RRC inactive state.

In one embodiment, the third message indicates that the first node switches from the RRC connected state to the RRC inactive state.

In one embodiment, the third message indicates that the first node switches from the RRC inactive state back to the RRC inactive state.

In one embodiment, the third message indicates that the first node switches from the RRC idle state to the RRC inactive state.

In one embodiment, when the third message indicates that the first node switches from the RRC connected state to the RRC inactive state, the first timer is set up.

In one embodiment, when the third message indicates that the first node switches from the RRC idle state to the RRC inactive state, the first timer is set up.

In one embodiment, only when the first node is in the RRC inactive state will the first timer be setup.

In one embodiment, when the first node is in the RRC_IDLE state or the RRC_Connected state, the first timer is released.

In one embodiment, the first timer only runs while the first node is in the RRC inactive state.

In one embodiment, a time of receiving the third message is earlier than a time of transmitting the first message.

In one embodiment, a time of receiving the third message is earlier than a time of initiating a random access procedure to which the first message belongs.

In one embodiment, a time of receiving the third message is earlier than a time of transmitting an Msg1 comprised in a random access procedure to which the first message belongs.

In one embodiment, a time of receiving the third message is earlier than a time of transmitting an MsgA comprised in a random access procedure to which the first message belongs.

In one embodiment, the third message enables a first radio bearer set to be transmitted in the RRC inactive state.

In one embodiment, the phrase that the third message enables a first radio bearer set to be transmitted in the RRC inactive state comprises that: the third message indicates that the first radio bearer set is to be transmitted in the RRC inactive state, with a first condition set being satisfied.

In one embodiment, the first condition set comprises at least one condition.

In one embodiment, the first condition set only comprises that a data volume in the first radio bearer set buffered before transmitting the first message is no larger than a first threshold.

In one embodiment, the first condition set only comprises that a data volume in the first radio bearer set buffered before transmitting the first message is smaller than a first threshold.

In one embodiment, the first condition set comprises that a data volume in the first radio bearer set transmitted after transmitting the first message and before receiving the second message is no larger than a first threshold.

In one embodiment, the first condition set comprises that a data volume in the first radio bearer set transmitted after transmitting the first message and before receiving the second message is smaller than a first threshold.

In one embodiment, the first condition set comprises being uplink synchronized with a receiver of the first message before transmitting the first message.

In one embodiment, the first condition set comprises that a Reference Signal Received Power (RSRP) of the receiver of the first message measured by a transmitter of the first message is no smaller than a second threshold; the second threshold is configured by the network or pre-configured.

In one embodiment, the first condition set comprises at least a first one of the following three conditions: a data volume in the first radio bearer set buffered before transmitting the first message being no larger than a first threshold; being uplink synchronized with a receiver of the first message before transmitting the first message; or an RSRP of the receiver of the first message measured by a transmitter of the first message being no smaller than a second threshold.

In one embodiment, the first condition set comprises at least a first one of the following three conditions: a data volume in the first radio bearer set buffered before transmitting the first message being smaller than a first threshold; being uplink synchronized with a receiver of the first message before transmitting the first message; or an RSRP of the receiver of the first message measured by a transmitter of the first message being no smaller than a second threshold.

In one embodiment, when each condition in the first condition set is satisfied, the first radio bearer set is transmitted in the RRC inactive state.

In one embodiment, when any condition in the first condition set is not satisfied, the first radio bearer set is transmitted in the RRC connected state.

In one embodiment, a name of a field comprised by the third message includes SDT.

In one embodiment, the third message indicates the first radio bearer set; the first radio bearer set comprises at least one RB.

In one embodiment, the third message comprises a first radio bearer identifier set, the first radio bearer identifier set comprising at least one radio bearer identifier; any radio bearer identifier in the first radio bearer identifier set indicates a radio bearer in the first radio bearer set.

In one embodiment, any radio bearer in the first radio bearer set is a Data Radio Bearer (DRB).

In one embodiment, any radio bearer in the first radio bearer set includes a Packet Data Convergence Protocol (PDCP) bearer.

In one embodiment, any radio bearer in the first radio bearer set includes an RLC bearer.

In one embodiment, any radio bearer in the first radio bearer set includes an RLC channel.

In one embodiment, any first-type data unit belongs to a radio bearer in the first radio bearer set.

In one embodiment, any first-type data unit is transmitted through a radio bearer in the first radio bearer set.

In one embodiment, a first data unit set is received after receiving the third message and before transmitting the first message.

In one embodiment, after receiving the third message and before initiating a random access procedure to which the first message belongs, the first data unit set is received.

In one embodiment, after receiving the third message and before transmitting an Msg1 comprised by a random access procedure to which the first message belongs, the first data unit set is received.

In one embodiment, after receiving the third message and before transmitting an MsgA comprised by a random access procedure to which the first message belongs, the first data unit set is received.

In one embodiment, after receiving the third message and before initiating a SDT procedure to which the first message belongs, the first data unit set is received.

In one embodiment, the first message is a first of all messages comprising the first-type data unit that is transmitted after receiving the third message.

In one embodiment, the first data unit set is received from an upper layer of the first node; the upper layer is a NAS.

In one embodiment, the first data unit set is received through an air interface.

In one embodiment, the first data unit set comprises at least one data unit.

In one embodiment, any data unit in the first data unit set belongs to the first-type data unit.

In one embodiment, any data unit in the first data unit set belongs to one radio bearer in the first radio bearer set.

In one embodiment, a data volume in the first data unit set is no larger than a first threshold.

In one embodiment, a data volume in the first data unit set is smaller than the first threshold.

In one embodiment, the data volume in the first data unit set comprises at least one bit.

In one embodiment, the data volume in the first data unit set comprises at least one byte.

In one embodiment, the first data unit set comprises all currently-buffered data units.

In one embodiment, the first data unit set comprises all data units currently buffered in a MAC sublayer.

In one embodiment, the first data unit set comprises all data units currently buffered in a MAC sublayer and an RLC sublayer.

In one embodiment, the first data unit set comprises all data units currently buffered in a MAC sublayer, an RLC sublayer and a PDCP sublayer.

In one embodiment, the data volume in the first data unit set comprises values obtained by bit numbers of all bits comprised by the first data unit set being divided by 8.

In one embodiment, the data volume in the first data unit set is expressed in byte(s).

In one embodiment, the first threshold is configured by the network.

In one embodiment, the first threshold is pre-configured.

In one embodiment, the first threshold is a fixed value.

In one embodiment, the first threshold is specified.

In one embodiment, the first threshold is configured by a SIB.

In one embodiment, the first threshold is configured by a SIB1.

In one embodiment, the first threshold is configured by an RRC signaling.

In one embodiment, the first threshold is carried in all or partial Information Elements (IEs) in an RRC signaling.

In one embodiment, the first threshold is carried in all or partial fields of an IE in an RRC signaling.

In one embodiment, the first threshold is expressed in byte(s).

In one embodiment, as a response to receiving the first data unit set, transmitting the first message.

In one embodiment, as a response to receiving the first data unit set, triggering a random access procedure to which the first message belongs.

In one embodiment, as a response to receiving the first data unit set, triggering a SDT procedure.

In one embodiment, the first node is in the RRC inactive state when transmitting the first message; the first message comprises at least partial bits in at least one first-type data unit comprised by the first data unit set.

In one embodiment, a most recent start of the first timer is accompanied by the first message.

In one embodiment, the phrase of first-type data unit(s) transmitted after a most recent start of the first timer comprises: first-type data unit(s) transmitted after a most recent start of the first timer includes/include the first-type data unit(s) comprised by the first message; herein, the most recent start of the first timer is accompanied by the first message.

In one embodiment, the action of maintaining a first timer comprises: along with the first message, starting the first timer.

In one embodiment, the phrase that along with the first message, starting the first timer comprises that: transmitting the first message and starting the first timer are inseparable (that is, atomic).

In one embodiment, the phrase that along with the first message, starting the first timer comprises that: transmitting the first message and starting the first timer are mutually accompanied.

In one embodiment, the phrase that along with the first message, starting the first timer comprises that: transmitting the first message is used for triggering the start of the first timer.

In one embodiment, the phrase that along with the first message, starting the first timer comprises that: upon transmission of the first message, starting the first timer.

In one embodiment, the phrase that along with the first message, starting the first timer comprises that: following the transmission of the first message, starting the first timer.

In one embodiment, the phrase that along with the first message, starting the first timer comprises that: following the start of the first timer, transmitting the first message.

In one embodiment, the phrase that along with the first message, starting the first timer comprises that: upon initiation of the procedure of random access to which the first message belongs, starting the first timer.

In one embodiment, the phrase that along with the first message, starting the first timer comprises that: following the initiation of the procedure of random access to which the first message belongs, starting the first timer.

In one embodiment, the phrase that along with the first message, starting the first timer comprises that: following the start of the first timer, initiating the procedure of random access to which the first message belongs.

In one embodiment, the phrase that along with the first message, starting the first timer comprises that: upon initiation of a small data transmission (SDT) procedure to which the first message belongs, starting the first timer.

In one embodiment, the phrase that along with the first message, starting the first timer comprises that: following the initiation of a small data transmission (SDT) procedure to which the first message belongs, starting the first timer.

In one embodiment, the phrase that along with the first message, starting the first timer comprises that: following the start of the first timer, initiating a small data transmission (SDT) procedure to which the first message belongs.

In one embodiment, the phrase that along with the first message, starting the first timer comprises that: upon transmission of a first said first-type data unit after transmitting the first message, starting the first timer.

In one embodiment, the phrase that along with the first message, starting the first timer comprises that: upon reception of a first said first-type data unit after transmitting the first message, starting the first timer.

In one embodiment, the phrase that along with the first message, starting the first timer comprises that: transmitting the first message does not start a timer T319.

In one embodiment, transmitting the first-type data unit does not start or restart the T319.

In one embodiment, along with the first message, starting the first timer, the first message comprising at least partial bits in at least one of the first-type data units; along with a fourth message, starting the timer T319, the fourth message not comprising the first-type data unit(s).

In one embodiment, the first timer and the timer T319 are orthogonal in running time.

In one embodiment, the fourth message comprises an RRC signaling.

In one embodiment, the fourth message comprises a RRCResumeRequest.

In one embodiment, the fourth message comprises a RRCResumeRequest1.

In one embodiment, a MAC SDU comprised by the fourth message only comprises an RRC signaling.

In one embodiment, a MAC SDU comprised by the fourth message only comprises a CCCH.

In one embodiment, a random access procedure to which the first message belongs is used for SDT; a random access procedure to which the fourth message belongs is used for functions other than SDT.

In one embodiment, a random access procedure to which the fourth message belongs is used for an initial access to an RRC idle state.

In one embodiment, a random access procedure to which the fourth message belongs is used for an RRC re-establishment procedure.

In one embodiment, a random access procedure to which the fourth message belongs is used for implementing uplink synchronization.

In one embodiment, a random access procedure to which the fourth message belongs is used for acquiring uplink transmission resource.

In one embodiment, a random access procedure to which the fourth message belongs is used for a Scheduling Request (SR) failure.

In one embodiment, a random access procedure to which the fourth message belongs is used for handover.

In one embodiment, a random access procedure to which the fourth message belongs is used for switching from an RRC inactive state to an RRC state.

In one embodiment, a random access procedure to which the fourth message belongs is used for setting up time alignment with a Timing Advance Group (TAG).

In one embodiment, a random access procedure to which the fourth message belongs is used for acquiring other system information.

In one embodiment, a random access procedure to which the fourth message belongs is used for a beam failure recovery.

In one embodiment, a random access procedure to which the fourth message belongs is used for constant uplink Listen Before Talk (LBT) failures on a Special Cell (SpCell).

In one embodiment, the phrase of starting the first timer comprises: the first timer beginning its time counting.

In one embodiment, the number of the first-type data unit(s) transmitted after a most recent start of the first timer is calculated in a MAC sublayer.

In one embodiment, as a response to that the number of first-type data unit(s) transmitted after a most recent start of the first timer exceeds the first threshold, conveying a first indication from a MAC sublayer to upper layer(s); the upper layer is an RRC sublayer; both the MAC sublayer and the RRC sublayer belong to the first node.

In one embodiment, an RRC sublayer of the first node receives the first indication; the first indication is used for triggering the action of restarting the first timer.

In one embodiment, the second message comprises a RRCRelease, and the RRCRelease does not comprise a SuspendConfig field; the second message indicates that the RRC state of the first node is the RRC idle state.

In one embodiment, the second message comprises a RRCRelease, and the RRCRelease comprises a SuspendConfig field; the second message indicates that the RRC state of the first node is the RRC inactive state.

In one embodiment, the second message comprises a RRCReject; the second message indicates that the RRC state of the first node is the RRC idle state.

In one embodiment, the second message comprises a RRCResume; the second message indicates that the RRC state of the first node is an RRC connected state.

In one embodiment, the second message comprises a RRCSetup; the second message indicates that the RRC state of the first node is the RRC connected state.

In one embodiment, the second message comprises a RRCReestablishment; the second message indicates that the RRC state of the first node is the RRC connected state.

In one embodiment, when the second message indicates that the RRC state of the first node is the RRC connected state, the first timer is released.

In one embodiment, when the second message indicates that the RRC state of the first node is the RRC idle state, the first timer is released.

In one embodiment, the first node is in the RRC inactive state from after transmitting the first message till before receiving the second message.

In one embodiment, the first node is in the RRC inactive state from after transmitting the first message till the first timer is expired.

### Embodiment 6A

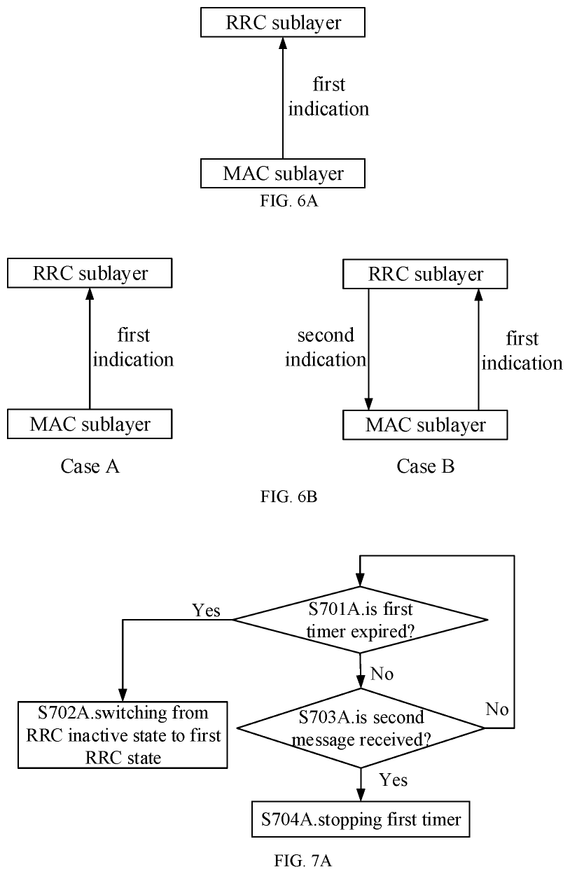

Embodiment 6A illustrates a schematic diagram of inter-layer information interaction between an RRC sublayer and a MAC sublayer according to one embodiment of the present application, as shown in FIG. 6A. An RRC sublayer and a MAC sublayer in FIG. 6A both belong to the first node.

In one embodiment, upon transmission of the first message, start the second timer; the first message comprises at least partial bits in at least one said first-type data unit.

In one embodiment, as a response to a MAC sublayer of the first node transmitting the first-type data unit or as a response to the MAC sublayer of the first node receiving the first-type data unit, start or restart the second timer.

In one embodiment, as a response to the second timer being expired, the first indication is conveyed from a MAC sublayer of the first node to an RRC sublayer of the first node; the first indication is used to indicate that the second timer is not in the running state.

In one embodiment, a reception of the first-type data unit or a transmission of the first-type data unit is identified in a MAC sublayer.

In one embodiment, any data unit of the first-type data unit(s) belongs to the first radio bearer set; the first radio bearer set and a first logical channel identifier set are associated; any radio bearer in the first radio bearer set is indicated by a logical channel identifier in the first logical channel identifier set.

In one embodiment, the phrase that the first radio bearer set and the first logical channel identifier set are associated comprises that: when configuring a radio bearer in the first radio bearer set, both an identifier of the radio bearer and a logical channel identifier of the radio bearer are included.

In one embodiment, a MAC subPDU comprises a MAC subheader and a MAC SDU, where the MAC subheader comprises a logical channel identifier, the logical channel identifier indicating a radio bearer to which the MAC SDU belongs.

In one embodiment, whether a MAC SDU of the MAC subPDU comprises bits of the first-type data unit(s) is identified by a MAC subheader of a MAC subPDU in a MAC sublayer; when the MAC subheader of the MAC subPDU comprises any logical channel identifier in the first logical channel identifier set, the MAC SDU of the MAC subPDU comprises bits of the first-type data unit(s); when the MAC subheader of the MAC subPDU comprises a logical channel identifier other than the first logical channel identifier set, the MAC SDU of the MAC subPDU comprises no bits of the first-type data unit(s).

In one embodiment, when the first node is in the RRC idle state, the second timer stops time counting.

In one embodiment, when the first node is in the RRC connected state, the second timer stops time counting.

In one embodiment, only when the first node is in the RRC inactive state will the first timer be setup.

In one embodiment, when the first node is in the RRC_IDLE state or the RRC_Connected state, the first timer is released.

### Embodiment 6B

Embodiment 6B illustrates a schematic diagram of inter-layer information interaction between an RRC sublayer and a MAC sublayer according to one embodiment of the present application, as shown in FIG. 6B. An RRC sublayer and a MAC sublayer in FIG. 6B both belong to the first node.

In one embodiment, a first counter is maintained in a MAC sublayer, the first counter being used for counting the number of the first-type data unit(s) transmitted through the MAC sublayer of the first node.

In one embodiment, any data unit of the first-type data unit(s) belongs to the first radio bearer set; the first radio bearer set and a first logical channel identifier set are associated; any radio bearer in the first radio bearer set is indicated by a logical channel identifier in the first logical channel identifier set.

In one embodiment, the phrase that the first radio bearer set and the first logical channel identifier set are associated comprises that: when configuring a radio bearer in the first radio bearer set, both an identifier of the radio bearer and a logical channel identifier of the radio bearer are included.

In one embodiment, a MAC subPDU comprises a MAC subheader and a MAC SDU, where the MAC subheader comprises a logical channel identifier, the logical channel identifier indicating a radio bearer to which the MAC SDU belongs.

In one embodiment, whether a MAC SDU of the MAC subPDU comprises bits of the first-type data unit(s) is identified by a MAC subheader of a MAC subPDU in a MAC sublayer; when the MAC subheader of the MAC subPDU comprises any logical channel identifier in the first logical channel identifier set, the MAC SDU of the MAC subPDU comprises bits of the first-type data unit(s); when the MAC subheader of the MAC subPDU comprises a logical channel identifier other than the first logical channel identifier set, the MAC SDU of the MAC subPDU comprises no bits of the first-type data unit(s).

In one embodiment, upon initiation of a random access procedure comprising the first message, the first counter starts counting.

In one embodiment, upon initiation of a SDT procedure comprising the first message, the first counter starts counting.

In one embodiment, upon transmission of the first message, the first counter starts counting.

In one embodiment, along with the first message, the first counter starts counting.

In one embodiment, the phrase that along with the first message, the first counter starts counting comprises that: transmitting the first message and the first counter starting counting are inseparable (that is, atomic).

In one embodiment, the phrase that along with the first message, the first counter starts counting comprises that: transmitting the first message and the first counter starting counting are mutually accompanied.

In one embodiment, the phrase that along with the first message, the first counter starts counting comprises that: transmitting the first message is used for triggering that the first counter starts counting.

In one embodiment, the phrase that along with the first message, the first counter starts counting comprises that: upon transmission of the first message, the first counter starts counting.

In one embodiment, the phrase that along with the first message, the first counter starts counting comprises that: following the transmission of the first message, the first counter starts counting.

In one embodiment, the phrase that along with the first message, the first counter starts counting comprises that: following that the first counter starts counting, transmitting the first message.

In one embodiment, the phrase that along with the first message, the first counter starts counting comprises that: upon initiation of the procedure of random access to which the first message belongs, the first counter starts counting.

In one embodiment, the phrase that along with the first message, the first counter starts counting comprises that: following the initiation of the procedure of random access to which the first message belongs, the first counter starts counting.

In one embodiment, the phrase that along with the first message, the first counter starts counting comprises that: following that the first counter starts counting, initiating the procedure of random access to which the first message belongs.

In one embodiment, the phrase that along with the first message, the first counter starts counting comprises that: upon initiation of a small data transmission (SDT) procedure to which the first message belongs, the first counter starts counting

In one embodiment, the phrase that along with the first message, the first counter starts counting comprises that: following the initiation of a small data transmission (SDT) procedure to which the first message belongs, the first counter starts counting.

In one embodiment, the phrase that along with the first message, the first counter starts counting comprises that: following that the first counter starts counting, initiating a small data transmission (SDT) procedure to which the first message belongs.

In one embodiment, when the first counter exceeds the first threshold, the first counter stops counting.

In one embodiment, when the first counter exceeds the first threshold, the first counter restarts counting.

In one embodiment, upon reception of the second message, the first counter stops counting.

In one embodiment, when the first node is in the RRC idle state, the first counter stops counting.

In one embodiment, when the first node is in the RRC connected state, the first counter stops counting.

In one embodiment, only when the first node is in the RRC inactive state will the first counter be setup.

In one embodiment, when the first node is in the RRC_IDLE state or the RRC_Connected state, the first counter is released.

In one embodiment, the phrase that the first counter exceeds the first threshold comprises that: the first counter is of a value greater than the first threshold.

In one embodiment, the phrase that the first counter exceeds the first threshold comprises that: the first counter is of a value equal to the first threshold.

In one embodiment, the phrase that the first counter exceeds the first threshold comprises that: the first counter is of a value no less than the first threshold.

In one embodiment, as a response to that the first timer starts or restarts, the first counter starts counting.

In one embodiment, as a response to that the first timer starts or restarts, a second indication is transmitted from an RRC sublayer to a lower layer, the second indication being used to indicate that the first counter starts counting; the lower layer is a MAC sublayer.

In one embodiment, the phrase that the first counter starts counting or restarts counting comprises: setting the value of the first counter to 0.

In Case A of Embodiment 6, as a response to that the number of first-type data unit(s) transmitted after a most recent start of the first timer exceeds the first threshold, a first indication is conveyed from a MAC sublayer of the first node to an RRC sublayer of the first node; the first indication is used for triggering the restart of the first timer; the first counter restarts counting.

In Case B of Embodiment 6, as a response to that the number of first-type data unit(s) transmitted after a most recent start of the first timer exceeds the first threshold, a first indication is conveyed from a MAC sublayer of the first node to an RRC sublayer of the first node; the first indication is used for triggering the restart of the first timer; as a response to that the first timer starts or restarts, the second indication is transmitted from an RRC sublayer of the first node to a MAC sublayer of the first node, the second indication being used to trigger that the first counter restarts counting.

### Embodiment 7A

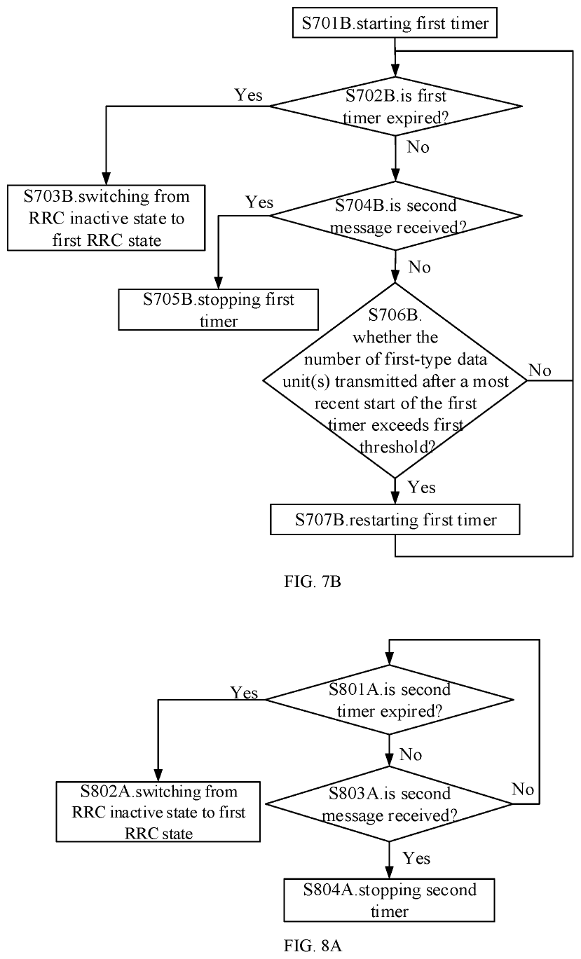

Embodiment 7A illustrates a flowchart of processing while a second timer is not in a running state according to one embodiment of the present application, as shown in FIG. 7A. Steps in FIG. 7A are performed by the first node.

In FIG. 7A, determining in step S701A whether a first timer is expired; if so, performing step S702A; if not, performing step S703A; in step S702A, switching from an RRC inactive state to a first RRC state; in step S703A, determining whether a second message is received; if so, performing step S704A; if not, skip to step S701A; and stopping a first timer in step S704A.

In one embodiment, upon reception of the second message, the first timer is in the running state, while the second timer is not in the running state.

In one embodiment, along with a switch from the RRC inactive state to the first RRC state, stop the first timer.

In one embodiment, after having switched from the RRC inactive state to the first RRC state, the first timer is not in a running state.

In one embodiment, after having switched from the RRC inactive state to the RRC idle state, the first timer is not in a running state.

In one embodiment, after having switched from the RRC inactive state to the RRC connected state, the first timer is not in a running state.

### Embodiment 7B

Embodiment 7B illustrates a flowchart of processing of a first node according to one embodiment of the present application, as shown in FIG. 7B. Steps in FIG. 7B are performed by the first node.

In FIG. 7B, starting a first timer in step S701B; determining in step S702B whether a first timer is expired; if so, performing step S703B; if not, performing step S704B; in step S703B, switching from an RRC inactive state to a first RRC state; in step S704B, determining whether a second message is received; if so, performing step S705B; if not, performing step S706B; and stopping a first timer in step S705B; and determining in step S706B whether a number of first-type data unit(s) transmitted after a most recent start of the first timer exceeds a first threshold; if so, performing step S707B; if not, skip to step S702B; and restarting the first timer in step S707B.

In one embodiment, when transmitting the first-type data unit(s) after a most recent start of the first timer, the first timer is in a running state.

In one embodiment, after the first timer is expired, suspense in the RRC inactive state in which the first-type data unit(s) is(are) transmitted.

In one embodiment, after having switched from the RRC inactive state to the first RRC state, the first timer is not in the running state.

In one embodiment, after having switched from the RRC inactive state to the RRC idle state, the first timer is not in the running state.

In one embodiment, after having switched from the RRC inactive state to the RRC connected state, the first timer is not in the running state.

### Embodiment 8A

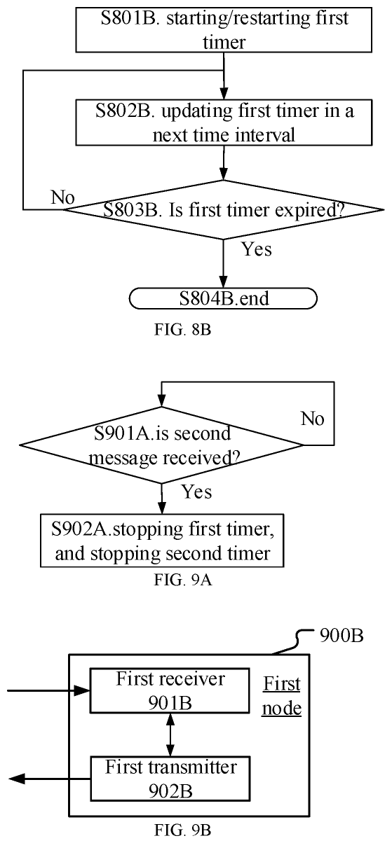

Embodiment 8A illustrates a flowchart of processing while a first timer is not in a running state according to one embodiment of the present application, as shown in FIG. 8A. Steps in FIG. 8A are performed by the first node.

In FIG. 8A, determining in step S801A whether a second timer is expired; if so, performing step S802A; if not, performing step S803A; in step S802A, switching from an RRC inactive state to a first RRC state; in step S803A, determining whether a second message is received; if so, performing step S804A; if not, skip to step S801A; and stopping a second timer in step S804A.

In one embodiment, upon reception of the second message, the second timer is in the running state, while the first timer is not in the running state.

In one embodiment, along with a switch from the RRC inactive state to the first RRC state, stop the second timer.

In one embodiment, after having switched from the RRC inactive state to the first RRC state, the second timer is not in a running state.

In one embodiment, after having switched from the RRC inactive state to the RRC idle state, the second timer is not in a running state.

In one embodiment, after having switched from the RRC inactive state to the RRC connected state, the second timer is not in a running state.

In one embodiment, if a second message is received, and the second timer is in the running state, as a response to receiving the second message, stopping the second timer.

### Embodiment 8B

Embodiment 8B illustrates a flowchart of a first timer according to one embodiment of the present application, as shown in FIG. 8B. Steps in FIG. 8B are performed by the first node.

In step S801B, starting or restarting a first timer; in step S802B, updating the first timer in a next time interval; and in step S803B, determining whether the first timer is expired, if so, come to an end, if not, go back to step S802B.

In one embodiment, when the first timer is running, the first timer is updated per said time interval.

In one embodiment, when the first timer is not in the running state, stop updating the first timer per said time interval.

In one embodiment, the time interval is 1 millisecond (ms).

In one embodiment, the time interval is a subframe.

In one embodiment, the time interval is a slot, where a time-length of the slot is related to a subcarrier spacing in frequency domain.

In one embodiment, the time interval comprises 14 multicarrier symbols.

In one embodiment, the time interval comprises 12 multicarrier symbols.

In one embodiment, a first expiration value of the first timer is configured by the network.

In one embodiment, the first expiration value of the first timer is configured by an RRC signaling.

In one embodiment, the first expiration value of the first timer is configured by a SIB.

In one embodiment, the first expiration value of the first timer is configured by a SIB1.

In one embodiment, the first expiration value of the first timer is carried in all or partial Information Elements (IEs) in an RRC signaling.

In one embodiment, the first expiration value of the first timer is carried in all or partial fields of an IE in an RRC signaling.

In one embodiment, the first expiration value of the first timer is expressed in milliseconds.

In one embodiment, the first expiration value of the first timer is expressed in subframes.

In one embodiment, the first expiration value of the first timer is expressed in slots.

In one embodiment, a value of the first timer is set to 0 when starting or restarting the first timer, the phrase of updating the first timer comprising: incrementing the value of the first timer by 1; when the value of the first timer is the first expiration value of the first timer, the first timer is expired.

In one embodiment, a value of the first timer is set to the first expiration value of the first timer when starting or restarting the first timer, the phrase of updating the first timer comprising: decrementing the value of the first timer by 1; when the value of the first timer is 0, the first timer is expired.

In one embodiment, the first timer stops time counting upon expiration.

In one embodiment, when the first node transmits or receives the first-type data unit, the first timer is running.

In one embodiment, when the time interval is 1 ms, the next time interval is an incoming 1 millisecond.

In one embodiment, when the time interval is a subframe, the next time interval is an incoming subframe.

In one embodiment, when the time interval is a slot, the next time interval is an incoming slot.

### Embodiment 9A

Embodiment 9A illustrates a flowchart of processing while a first timer is in a running state and a second timer is in a running state according to one embodiment of the present application, as shown in FIG. 9A. Steps in FIG. 9A are performed by the first node.

In FIG. 9A, determining in step S901A whether a second message is received; if so, performing step S902A; if not, skip back to step S901A.

In one embodiment, upon reception of the second message, the first timer and the second timer are respectively in the running state.

In one embodiment, if a second message is received, and the first timer and the second timer are respectively in the running state, as a response to receiving the second message, stop the first timer and stop the second timer.

### Embodiment 9B

Embodiment 9B illustrates a structure block diagram of a processing device in a first node according to one embodiment of the present application, as shown in FIG. 9B. In FIG. 9B, a first node processing device 900B comprises a first receiver 901B and a first transmitter 902B. The first receiver 901B comprises at least one of the transmitter/receiver 454 (comprising the antenna 452), the receiving processor 456, the multi-antenna receiving processor 458 or the controller/processor 459 in FIG. 4 of the present application; the first transmitter 902B comprises at least one of the transmitter/receiver 454 (comprising the antenna 452), the transmitting processor 468, the multi-antenna transmitting processor 457 or the controller/processor 459 in FIG. 4 of the present application.

In Embodiment 9B, the first receiver 901B maintains a first timer; the first transmitter 902B transmits a first message, the first message comprising an RRC signaling; as a response to that the first timer is expired, switching from an RRC inactive state to a first RRC state; herein, the action of maintaining a first timer comprises: as a response to that a number of first-type data unit(s) transmitted after a most recent start of the first timer exceeds a first threshold, restarting the first timer; if a second message is received, as a response to receiving the second message, stopping the first timer, the second message comprising an RRC signaling, and the second message being used as a response to the first message; the first RRC state is a candidate state in a first candidate state set, the first candidate state set comprising an RRC idle state; the first threshold is configurable, or, the first threshold is a positive integer greater than 1.

In one embodiment, the first transmitter 902B, as a response to that a number of first-type data unit(s) transmitted after a most recent start of the first timer exceeds a first threshold, conveys a first indication from a MAC sublayer to upper layers; herein, the first indication is used for triggering the action of restarting the first timer, where the number of the first-type data unit(s) is calculated in the MAC sublayer.

In one embodiment, the first timer is maintained in an RRC sublayer.

In one embodiment, the first receiver 901B receives a third message; herein, a time of receiving the third message is earlier than a time of transmitting the first message; the third message enables a first radio bearer set to be transmitted in the RRC inactive state; any first-type data unit belongs to a radio bearer in the first radio bearer set.

In one embodiment, the first receiver 901B receives a third message; herein, a time of receiving the third message is earlier than a time of transmitting the first message; the third message enables a first radio bearer set to be transmitted in the RRC inactive state; any first-type data unit belongs to a radio bearer in the first radio bearer set; the first receiver 901B receives a first data unit set after receiving the third message and before transmitting the first message; herein, a data volume in the first data unit set is no larger than a first threshold; any data unit in the first data unit set belongs to the first-type data unit; the first node is in the RRC inactive state when transmitting the first message.

In one embodiment, the second message indicates an RRC state of the first node.

### Embodiment 10A

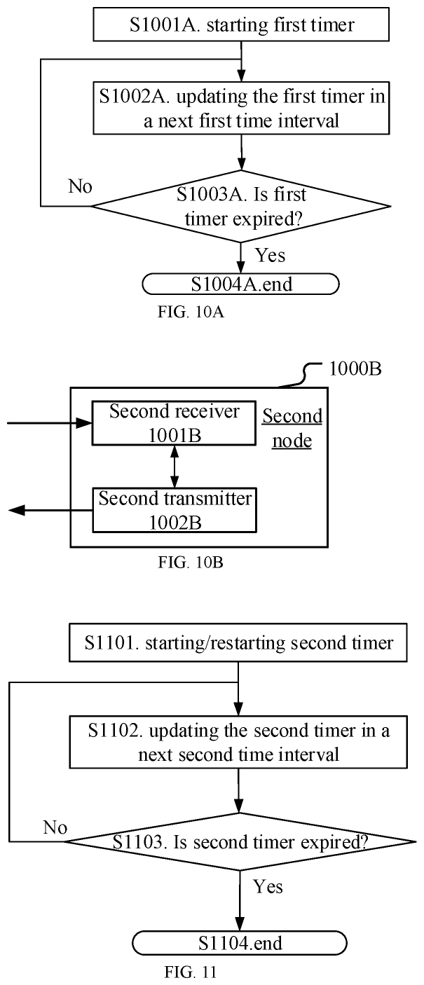

Embodiment 10A illustrates a flowchart of a first timer according to one embodiment of the present application, as shown in FIG. 10A. Steps in FIG. 10A are performed by the first node.

In step S1001A, a first timer is started; in step S1002A, the first timer is updated in a next first time interval; and in step S1003A, determining whether the first timer is expired, if so, come to an end, if not, go back to step S1002A.

In one embodiment, when the first timer is running, the first timer is updated per said first time interval.

In one embodiment, when the first timer is not running, stop updating the first timer per said first time interval.

In one embodiment, the first time interval is 1 millisecond (ms).

In one embodiment, the first time interval is a subframe.

In one embodiment, the first time interval is a slot, where a time-length of the slot is related to a subcarrier spacing in frequency domain.

In one embodiment, the first time interval comprises 14 multicarrier symbols.

In one embodiment, the first time interval comprises 12 multicarrier symbols.

In one embodiment, a first expiration value of the first timer is configured by the network.

In one embodiment, the first expiration value of the first timer is configured by an RRC signaling.

In one embodiment, the first expiration value of the first timer is configured by a SIB.

In one embodiment, the first expiration value of the first timer is configured by a SIB1.

In one embodiment, the first expiration value of the first timer is carried in all or partial IEs in an RRC signaling.

In one embodiment, the first expiration value of the first timer is carried in all or partial fields of an IE in an RRC signaling.

In one embodiment, the first expiration value of the first timer is expressed in milliseconds.

In one embodiment, the first expiration value of the first timer is expressed in subframes.

In one embodiment, the first expiration value of the first timer is expressed in slots.

In one embodiment, a value of the first timer is set to 0 when starting the first timer, the phrase of updating the first timer comprising: incrementing the value of the first timer by 1; when the value of the first timer is the first expiration value of the first timer, the first timer is expired.

In one embodiment, a value of the first timer is set to the first expiration value of the first timer when starting the first timer, the phrase of updating the first timer comprising: decrementing the value of the first timer by 1; when the value of the first timer is 0, the first timer is expired.

In one embodiment, the first timer stops time counting upon expiration.

In one embodiment, the first timer is not in the running state upon expiration.

In one embodiment, when the first node transmits or receives the first-type data unit, at least one of the first timer or the second timer is running.

In one embodiment, when the first time interval is 1 ms, the next first time interval is an incoming 1 millisecond.

In one embodiment, when the first time interval is a subframe, the next first time interval is an incoming subframe.

In one embodiment, when the first time interval is a slot, the next first time interval is an incoming slot.

### Embodiment 10B

Embodiment 10B illustrates a structure block diagram of a processing device in a second node according to one embodiment of the present application, as shown in FIG. 10B. In FIG. 10B, a second node processing device 1000B comprises a second receiver 1001B and a second transmitter 1002B. The second receiver 1001B comprises at least one of the transmitter/receiver 418 (comprising the antenna 420), the receiving processor 470, the multi-antenna receiving processor 472 or the controller/processor 475 in FIG. 4 of the present application; the second transmitter 1002B comprises at least one of the transmitter/receiver 418 (comprising the antenna 420), the transmitting processor 416, the multi-antenna transmitting processor 471 or the controller/processor 475 in FIG. 4 of the present application.

In Embodiment 10B, the second receiver 1001B receives a first message, the first message comprising an RRC signaling; herein, a first timer is maintained; as a response to that the first timer is expired, an RRC inactive state is switched to a first RRC state; the first timer being maintained comprises: as a response to that a number of first-type data unit(s) transmitted after a most recent start of the first timer exceeds a first threshold, the first timer being restarted; if a second message is received, as a response to receiving the second message, the first timer being stopped, the second message comprising an RRC signaling, and the second message being used as a response to the first message; the first RRC state is a candidate state in a first candidate state set, the first candidate state set comprising an RRC idle state; the first threshold is configurable, or, the first threshold is a positive integer greater than 1.

In one embodiment, as a response to that a number of first-type data unit(s) transmitted after a most recent start of the first timer exceeds a first threshold, a first indication is conveyed from a MAC sublayer to upper layer(s); herein, the first indication is used for triggering that the first timer is restarted, where the number of the first-type data unit(s) is calculated in the MAC sublayer.

In one embodiment, the first timer is maintained in an RRC sublayer.

In one embodiment, the second transmitter 1002B transmits a third message; herein, a time of transmitting the third message is earlier than a time of receiving the first message; the third message enables a first radio bearer set to be transmitted in the RRC inactive state; any first-type data unit belongs to a radio bearer in the first radio bearer set.

In one embodiment, the second transmitter 1002B transmits a third message; herein, a time of transmitting the third message is earlier than a time of receiving the first message; the third message enables a first radio bearer set to be transmitted in the RRC inactive state; any first-type data unit belongs to a radio bearer in the first radio bearer set; a first data unit set being received after transmitting the third message and before receiving the first message; herein, a data volume in the first data unit set is no larger than a first threshold; any data unit in the first data unit set belongs to the first-type data unit; a transmitter of the first message is in the RRC inactive state when transmitting the first message.

In one embodiment, the second message indicates an RRC state of the transmitter of the first message.

### Embodiment 11

Embodiment 11 illustrates a flowchart of a second timer according to one embodiment of the present application, as shown in FIG. 11. Steps in FIG. 11 are performed by the first node.

In step S1101, starting/restarting a second timer; in step S1102, updating the second timer in a next second time interval; and in step S1103, determining whether the second timer is expired, if so, come to an end, if not, skip back to step S1102.

In one embodiment, when the second timer is running, the second timer is updated per said second time interval.

In one embodiment, when the second timer is not in a running state, stop updating the second timer per said second time interval.

In one embodiment, the second time interval is 1 millisecond (ms).

In one embodiment, the second time interval is a subframe.

In one embodiment, the second time interval is a slot, where a time-length of the slot is related to a subcarrier spacing in frequency domain.

In one embodiment, the second time interval comprises 14 multicarrier symbols.

In one embodiment, the second time interval comprises 12 multicarrier symbols.

In one embodiment, a second expiration value of the second timer is configured by the network.

In one embodiment, the second expiration value of the second timer is configured by an RRC signaling.

In one embodiment, the second expiration value of the second timer is configured by a SIB.

In one embodiment, the second expiration value of the second timer is configured by a SIB1.

In one embodiment, the second expiration value of the second timer is carried in all or partial IEs in an RRC signaling.

In one embodiment, the second expiration value of the second timer is carried in all or partial fields of an IE in an RRC signaling.

In one embodiment, the second expiration value of the second timer is related to traffic features of the first radio bearer set.

In one embodiment, the third message comprises the second expiration value of the second timer.

In one embodiment, the third message enables the second timer.

In one embodiment, the phrase that the third message enables the second timer comprises that: a SetupRelease field of the second timer comprised by the third message is set to Setup.

In one embodiment, the second expiration value of the second timer is expressed in milliseconds.

In one embodiment, the second expiration value of the second timer is expressed in subframes.

In one embodiment, the second expiration value of the second timer is expressed in slots.

In one embodiment, a value of the second timer is set to 0 when starting or restarting the second timer, the phrase of updating the second timer comprising: incrementing the value of the second timer by 1; when the value of the second timer is the second expiration value of the second timer, the second timer is expired.

In one embodiment, a value of the second timer is set to the second expiration value of the second timer when starting or restarting the second timer, the phrase of updating the second timer comprising: decrementing the value of the second timer by 1; when the value of the second timer is 0, the second timer is expired.

In one embodiment, when the first expiration value of the first timer and the second expiration value of the second timer are expressed in a same unit, the first expiration value of the first timer is no less than the second expiration value of the second timer.

In one embodiment, when the first expiration value of the first timer and the second expiration value of the second timer are expressed in a same unit, the first expiration value of the first timer is less than the second expiration value of the second timer.

In one embodiment, the first time interval is identical to the second time interval.

In one embodiment, when the first time interval and the second time interval are expressed in a same unit, the first time interval is of a value identical to the second time interval.

In one embodiment, when the first time interval and the second time interval are expressed in a same unit, the first time interval is of a value different from the second time interval.

In one embodiment, the second timer stops time counting upon expiration.

In one embodiment, the second timer is not in the running state upon expiration.

In one embodiment, when the second time interval is 1 ms, the next second time interval is an incoming 1 millisecond.

In one embodiment, when the second time interval is a subframe, the next second time interval is an incoming subframe.

In one embodiment, when the second time interval is a slot, the next second time interval is an incoming slot.

### Embodiment 12

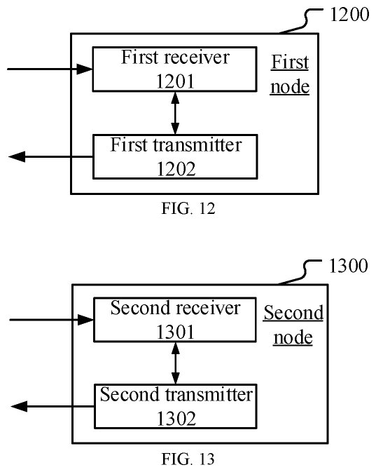

Embodiment 12 illustrates a structure block diagram of a processing device in a first node according to one embodiment of the present application, as shown in FIG. 12. In FIG. 12, a processing device 1200 in a first node is comprised of a first receiver 1201 and a first transmitter 1202. The first receiver 1201 comprises at least one of the transmitter/receiver 454 (comprising the antenna 452), the receiving processor 456, the multi-antenna receiving processor 458 or the controller/processor 459 in FIG. 4 of the present application; the first transmitter 1202 comprises at least one of the transmitter/receiver 454 (comprising the antenna 452), the transmitting processor 468, the multi-antenna transmitting processor 457 or the controller/processor 459 in FIG. 4 of the present application.

In Embodiment 12, the first receiver 1201 maintains a first timer, and maintains a second timer; the first transmitter 1202 transmits a first message, the first message comprising an RRC signaling; and determines whether to switch an RRC state according to both a state of the first timer and a state of the second timer; herein, the action of maintaining a first timer comprises: along with the first message, starting the first timer; the action of maintaining a second timer comprises: as a response to receiving a first-type data unit or as a response to transmitting the first-type data unit, starting or restarting the second timer; the action of determining whether to switch an RRC state according to both a state of the first timer and a state of the second timer comprises: when the second timer is not in a running state, as a response to that the first timer is expired, switching from an RRC inactive state to a first RRC state, or when the second timer is in the running state, that the first timer is expired not triggering a switch from the RRC inactive state to the first RRC state; the first RRC state is a candidate state in a first candidate state set, the first candidate state set comprising an RRC idle state.

In one embodiment, when the first timer is not in a running state, as a response to that the second timer is expired, the RRC inactive state is switched to the first RRC state; when the first timer is in the running state, that the second timer is expired does not trigger a switch from the RRC inactive state to the first RRC state.

In one embodiment, the first receiver 1201, as a response to that the second timer is expired, conveys a first indication from a MAC sublayer to upper layers; herein, the second timer is maintained in the MAC sublayer; the first timer is maintained in an RRC sublayer.

In one embodiment, the first receiver 1201 receives a third message; herein, a time of receiving the third message is earlier than a time of transmitting the first message; the third message enables a first radio bearer set to be transmitted in the RRC inactive state; any first-type data unit belongs to a radio bearer in the first radio bearer set.

In one embodiment, the first receiver 1201 receives a third message; herein, a time of receiving the third message is earlier than a time of transmitting the first message; the third message enables a first radio bearer set to be transmitted in the RRC inactive state; any first-type data unit belongs to a radio bearer in the first radio bearer set; the first receiver 1201 receives a first data unit set after receiving the third message and before transmitting the first message; herein, a data volume in the first data unit set is no larger than a first threshold; any data unit in the first data unit set belongs to the first-type data unit; the first node is in the RRC inactive state when transmitting the first message.

In one embodiment, the first receiver 1201, if a second message is received, and the second timer is in the running state, as a response to receiving the second message, stops the second timer; herein, the second message comprises an RRC signaling, and the second message is a response to the first message; the second message indicates the RRC state of the first node.

### Embodiment 13

Embodiment 13 illustrates a structure block diagram of a processing device in a second node according to one embodiment of the present application, as shown in FIG. 13. In FIG. 13, a processing device 1300 in the second node comprises a second receiver 1301 and a second transmitter 1302. The second receiver 1301 comprises at least one of the transmitter/receiver 418 (comprising the antenna 420), the receiving processor 470, the multi-antenna receiving processor 472 or the controller/processor 475 in FIG. 4 of the present application; the second transmitter 1302 comprises at least one of the transmitter/receiver 418 (comprising the antenna 420), the transmitting processor 416, the multi-antenna transmitting processor 471 or the controller/processor 475 in FIG. 4 of the present application.

In Embodiment 13, the second receiver 1301 receives a first message, the first message comprising an RRC signaling; a state of a first timer and a state of a second timer are used together for determining whether to switch an RRC state; herein, the first timer is maintained, and the second timer is maintained; the first timer being maintained comprises: along with the first message, the first timer being started; the second timer being maintained comprises: as a response to receiving a first-type data unit or as a response to transmitting the first-type data unit, the second timer being started or restarted; that a state of a first timer and a state of a second timer are used together for determining whether to switch an RRC state comprises: when the second timer is not in a running state, as a response to that the first timer is expired, an RRC inactive state being switched to a first RRC state, or when the second timer is in the running state, that the first timer is expired not triggering a switch from the RRC inactive state to the first RRC state; the first RRC state is a candidate state in a first candidate state set, the first candidate state set comprising an RRC idle state.

In one embodiment, when the first timer is not in a running state, as a response to that the second timer is expired, the RRC inactive state is switched to the first RRC state; when the first timer is in the running state, that the second timer is expired does not trigger a switch from the RRC inactive state to the first RRC state.

In one embodiment, as a response to that the second timer is expired, a first indication is conveyed from a MAC sublayer to upper layer(s); herein, the second timer is maintained in the MAC sublayer; the first timer is maintained in an RRC sublayer.

In one embodiment, the second transmitter 1302 transmits a third message; herein, a time of receiving the third message is earlier than a time of transmitting the first message; the third message enables a first radio bearer set to be transmitted in the RRC inactive state; any first-type data unit belongs to a radio bearer in the first radio bearer set.

In one embodiment, the second transmitter 1302 transmits a third message; herein, a time of receiving the third message is earlier than a time of transmitting the first message; the third message enables a first radio bearer set to be transmitted in the RRC inactive state; any first-type data unit belongs to a radio bearer in the first radio bearer set; a first data unit set being received after receiving the third message and before transmitting the first message; herein, a data volume in the first data unit set is no larger than a first threshold; any data unit in the first data unit set belongs to the first-type data unit; a transmitter of the first message is in the RRC inactive state when transmitting the first message.

In one embodiment, if a second message is received, and the first timer is in the running state, as a response to receiving the second message, the first timer is stopped; herein, the second message comprises an RRC signaling, and the second message is a response to the first message; the second message indicates the RRC state of the transmitter of the first message.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first-type communication node or UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The second-type communication node or base station or network-side device in the present application includes but is not limited to macro-cellular base stations, micro-cellular base stations, home base stations, relay base station, eNB, gNB, Transmitter Receiver Point (TRP), relay satellite, satellite base station, airborne base station and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, maintaining a first timer, and maintaining a second timer; and
a first transmitter, transmitting a first message, the first message comprising an RRC signaling; and determining whether to switch an RRC state according to both a state of the first timer and a state of the second timer;
wherein the action of maintaining a first timer comprises: along with the first message, starting the first timer; the action of maintaining a second timer comprises: as a response to receiving a first-type data unit or as a response to transmitting the first-type data unit, starting or restarting the second timer; the action of determining whether to switch an RRC state according to both a state of the first timer and a state of the second timer comprises: when the second timer is not in a running state, as a response to that the first timer is expired, switching from an RRC inactive state to a first RRC state, or when the second timer is in the running state, that the first timer is expired not triggering a switch from the RRC inactive state to the first RRC state; the first RRC state is a candidate state in a first candidate state set, the first candidate state set comprising an RRC idle state.

2. The first node according to claim 1, characterized in that the action of determining whether to switch an RRC state according to both a state of the first timer and a state of the second timer comprises: when the first timer is not in a running state, as a response to that the second timer is expired, switching from the RRC inactive state to the first RRC state; when the first timer is in the running state, that the second timer is expired not triggering a switch from the RRC inactive state to the first RRC state.

3. The first node according to claim 1, comprising:
the first receiver, as a response to that the second timer is expired, conveying a first indication from a MAC sublayer to upper layer(s);
wherein the second timer is maintained in the MAC sublayer; the first timer is maintained in an RRC sublayer.

4. The first node according to claim 1, comprising:
the first receiver, receiving a third message;
wherein a time of receiving the third message is earlier than a time of transmitting the first message; the third message enables a first radio bearer set to be transmitted in the RRC inactive state; any said first-type data unit belongs to a radio bearer in the first radio bearer set.

5. The first node according to claim 4, comprising:
the first receiver, receiving a first data unit set after receiving the third message and before transmitting the first message;
wherein a data volume in the first data unit set is no larger than a first threshold, the first threshold being network-configured or pre-configured; any data unit in the first data unit set belongs to the first-type data unit; the first node is in the RRC inactive state when transmitting the first message.

6. The first node according to claim 1, comprising:
the first receiver, receiving a second message when the first timer is in the running state; and as a response to receiving the second message, stopping the first timer;
wherein the second message comprises an RRC signaling, and the second message is a response to the first message; the second message indicates the RRC state of the first node.

7. A second node for wireless communications, comprising:
a second receiver, receiving a first message, the first message comprising an RRC signaling;
wherein a state of a first timer and a state of a second timer are used together by a transmitter of the first message for determining whether to switch an RRC state; the first timer is maintained by the transmitter of the first message, and the second timer is maintained by the transmitter of the first message; the first timer being maintained comprises: along with the first message, the first timer being started; the second timer being maintained comprises: as a response to receiving a first-type data unit or as a response to transmitting the first-type data unit, the second timer being started or restarted; that a state of a first timer and a state of a second timer are used together for determining whether to switch an RRC state comprises: when the second timer is not in a running state, as a response to that the first timer is expired, an RRC inactive state being switched to a first RRC state, or when the second timer is in the running state, that the first timer is expired not triggering a switch from the RRC inactive state to the first RRC state; the first RRC state is a candidate state in a first candidate state set, the first candidate state set comprising an RRC idle state.

8. The second node according to claim 7, characterized in that a state of a first timer and a state of a second timer are used together for determining whether to switch an RRC state comprises: when the first timer is not in a running state, as a response to that the second timer is expired, the RRC inactive state is switched to the first RRC state; when the first timer is in the running state, that the second timer is expired not triggering a switch from the RRC inactive state to the first RRC state.

9. The second node according to claim 7, characterized in that as a response to that the second timer is expired, a first indication is conveyed from a MAC sublayer to upper layer(s);
wherein the second timer is maintained in the MAC sublayer; the first timer is maintained in an RRC sublayer.

10. The second node according to claim 7, comprising:
a second transmitter, transmitting a third message;
wherein a time of transmitting the third message is earlier than a time of receiving the first message; the third message enables a first radio bearer set to be transmitted in the RRC inactive state; any said first-type data unit belongs to a radio bearer in the first radio bearer set.

11. The second node according to claim 10, characterized in that after receiving the third message and before transmitting the first message, a first data unit set is received;
wherein a data volume in the first data unit set is no larger than a first threshold, the first threshold being network-configured or pre-configured; any data unit in the first data unit set belongs to the first-type data unit; the transmitter of the first message is in the RRC inactive state when transmitting the first message.

12. The second node according to claim 7, comprising:
a second transmitter, transmitting a second message when the first timer is in the running state;
wherein as a response to receiving the second message, the first timer is stopped; the second message comprises an RRC signaling, and the second message is a response to the first message; the second message indicates the RRC state of the transmitter of the first message.

13. A method in a first node for wireless communications, comprising:
maintaining a first timer; and
maintaining a second timer; and
transmitting a first message, the first message comprising an RRC signaling; and
determining whether to switch an RRC state according to both a state of the first timer and a state of the second timer;
wherein the action of maintaining a first timer comprises: along with the first message, starting the first timer; the action of maintaining a second timer comprises: as a response to receiving a first-type data unit or as a response to transmitting the first-type data unit, starting or restarting the second timer; the action of determining whether to switch an RRC state according to both a state of the first timer and a state of the second timer comprises: when the second timer is not in a running state, as a response to that the first timer is expired, switching from an RRC inactive state to a first RRC state, or when the second timer is in the running state, that the first timer is expired is not used for triggering a switch from the RRC inactive state to the first RRC state; the first RRC state is a candidate state in a first candidate state set, the first candidate state set comprising an RRC idle state.

14. The method in the first node according to claim 13, characterized in that when the first timer is not in a running state, as a response to that the second timer is expired, the first timer switches from the RRC inactive state to the first RRC state; when the first timer is in the running state, that the second timer is expired does not trigger a switch from the RRC inactive state to the first RRC state.

15. The method in the first node according to claim 13, comprising:
as a response to that the second timer is expired, conveying a first indication from a MAC sublayer to upper layer(s);
wherein the second timer is maintained in the MAC sublayer; the first timer is maintained in an RRC sublayer.

16. The method in the first node according to claim 13, comprising:
receiving a third message;
wherein a time of receiving the third message is earlier than a time of transmitting the first message; the third message enables a first radio bearer set to be transmitted in the RRC inactive state; any said first-type data unit belongs to a radio bearer in the first radio bearer set.

17. The method in the first node according to claim 16, comprising:
receiving a first data unit set after receiving the third message and before transmitting the first message;
wherein a data volume in the first data unit set is no larger than a first threshold, the first threshold being network-configured or pre-configured; any data unit in the first data unit set belongs to the first-type data unit; the first node is in the RRC inactive state when transmitting the first message.

18. The method in the first node according to claim 13, comprising:
receiving a second message when the first timer is in the running state; and
as a response to receiving the second message, stopping the first timer;
wherein the second message comprises an RRC signaling, and the second message is a response to the first message; the second message indicates the RRC state of the first node.
